(19) United States
(12) Patent Application Publication
(10) Pub. No.: US 2020/0134434 A1
(43) Pub. Date: Apr. 30, 2020

(54) ARITHMETIC PROCESSING DEVICE, LEARNING PROGRAM, AND LEARNING METHOD

(71) Applicant: FUJITSU LIMITED, Kawasaki-shi (JP)

(72) Inventors: Takahiro Notsu, Kawasaki (JP); Wataru Kanemori, Fukuoka (JP)

(73) Assignee: FUJITSU LIMITED, Kawasaki-shi (JP)

(21) Appl. No.: 16/662,119

(22) Filed: Oct. 24, 2019

(30) Foreign Application Priority Data
Oct. 25, 2018 (JP) 2018-200993

(51) Int. Cl. G06N 3/063; G06F 7/544; G06F 17/18

(52) U.S. Cl. CPC G06N 3/063; G06F 17/18; G06F 7/5443

(57) ABSTRACT

An arithmetic processing device includes an arithmetic circuit; a register storing operation output data; a statistics acquisition circuit generating, from subject data being either the operation output data or normalization subject data, a bit pattern indicating a position of a leftmost set bit for positive number or a position of a leftmost zero bit for negative number of the subject data, the leftmost bit being a bit different from a sign bit; and a statistics aggregation circuit generating either positive or negative statistical information, or both positive and negative statistical information, by separately adding up a first number at respective bit positions of the leftmost set bit indicated by the bit pattern of each of a plurality of subject data having a positive sign bit and a second number of at respective bit positions of the leftmost zero bit indicated by the bit pattern of each of a plurality of subject data having a negative sign bit.

### CROSS-REFERENCE TO RELATED APPLICATION

This application is based upon and claims the benefit of priority of the prior Japanese Patent Application No. 2018-200993, filed on Oct. 25, 2018 the entire contents of which are incorporated herein by reference.

### FIELD

The present invention relates to an arithmetic processing device, a learning program, and a learning method,

### BACKGROUND

Deep learning (abbreviated to DL hereafter) is machine learning using a multilayer neural network. A deep neural network (abbreviated to DNN hereafter) is a network on which an input layer, a plurality of hidden layers, and an output layer are arranged sequentially. Each layer carries a single node or a plurality of nodes, and each node carries a value. The nodes on a certain layer and the nodes of the next layer are joined by edges, and each edge carries a variable (a parameter) known as a weight or a bias.

In a DNN, the values of the nodes on the respective layers are determined by executing predetermined arithmetic based on the value of the node on the preceding layer, the weight of the edge, and so on. When input data are input into the nodes of the input layer, the values of the nodes on the next layer are determined by a first predetermined arithmetic, whereupon the values of the nodes on further next layer are determined by a second predetermined arithmetic using data determined by the first predetermined arithmetic as input. The values of the nodes on the output layer, i.e. the final layer, serve as output data in relation to the input data.

In a DNN, batch normalization, in which a normalization layer for normalizing the output data of the preceding layer on the basis of the mean and the variance thereof is inserted between the current layer and the preceding layer and the output data are normalized in learning processing units (minibatch units), is performed. By inserting a normalization layer, bias in the distribution of the output data is corrected, and as a result, learning over the entire DNN proceeds efficiently. For example, in a DNN on which image data are used as the input data, a normalization layer is often provided after a convolution layer on which a convolution operation to the image data is performed.

Further, in a DNN, the input data are also normalized. In this case, a normalization layer is provided immediately after the input layer, the input data are normalized in learning units, and learning is executed on the normalized input data. In so doing, bias in the distribution of the input data is corrected, and as a result, learning over the entire DNN proceeds efficiently.

DNN is disclosed in Japanese Laid-open Patent Publication No. 2017-120609, Japanese Laid-open Patent Publication No. H07-121656 and Japanese Laid-open Patent Publication No, 2018-124681

### SUMMARY

In recent DNNs, in order to improve the recognition performance or the accuracy of the DNN, the amount of learning data is tend to increase. As a result of this increase, the calculation load on the DNN increases, leading to an increase in learning time and an increase in the load on a memory of a computer that executes operations in the DNN.

This problem applies similarly to the operation load of the normalization layer. For example, in a divisive normalization operation, the mean of the data values is determined, the variance of the data values is determined on the basis of the mean, and a normalization operation based on the mean and the variance is performed on the data values. When the number of minibatches increases in accordance with an increase in learning data, the resulting increase in the calculation load of the normalization operation leads to an increase in learning time and so on.

On aspect of the present embodiment is an arithmetic processing device including an arithmetic circuit; a register which stores operation output data that is output by the arithmetic circuit; a statistics acquisition circuit which generates, from subject data that is either the operation output data or normalization subject data, a bit pattern indicating a position of a leftmost set bit for positive number or a position of a leftmost zero bit for negative number of the subject data; and a statistics aggregation circuit which generates either positive statistical information or negative statistical information, or both positive and negative statistical information, by separately adding up a first number at respective bit positions of the leftmost set bit indicated by the bit pattern of each of a plurality of subject data having a positive sign bit and a second number of at respective bit positions of leftmost zero bit indicated by the bit pattern of each of a plurality of subject data having a negative sign bit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view depicting an example configuration of a deep neural network (DNN).

FIG. 2 is a view depicting a flowchart of an example of learning processing executed in the DNN.

FIG. 3 is a view illustrating the operation performed on the convolution layer.

FIG. 4 is a view depicting an arithmetic expression of the convolution operation.

FIG. 5 is a view illustrating the operation performed on the fully connected layer.

FIG. 6 is a view illustrating normalization on the batch normalization layer.

FIG. 7 is a view depicting a flowchart of a minibatch normalization operation.

FIG. 8 is a flowchart depicting processing performed on a convolution layer and a batch normalization layer (1) according to this embodiment.

FIG. 9 is a view illustrating the statistical information.

FIG. 10 is a view depicting a flowchart of the batch normalization processing according to this embodiment.

FIG. 11 is a view depicting a flowchart on which the processing of the convolution layer and the batch normalization layer according to this embodiment is performed by a vector arithmetic unit.

FIG. 12 is a view depicting a flowchart on which the processing of the convolution layer and the processing of the batch normalization layer according to this embodiment are performed separately,

FIG. 13 is a view depicting an example configuration of the deep learning (DL) system according to this embodiment.

FIG. 14 is a view depicting an example configuration of the host machine 30.

FIG. 15 is a view depicting an example configuration of the DL execution machine.

FIG. 16 is a schematic view of a sequence chart of the deep learning processing executed by the host machine and the DL execution machine.

FIG. 17 is a view depicting an example configuration of the DL execution processor 43.

FIG. 18 is a view depicting a flowchart of the convolution and normalization operations executed by DL execution processor of FIG. 17.

FIG. 19 is a flowchart illustrating in detail the processing of S51 for performing the convolution operation and updating the statistical information in FIG. 18.

FIG. 20 is a flowchart illustrating the processing executed by the DL execution processor to acquire, aggregate, and store the statistical information.

FIG. 21 is a view illustrating an example of a logic circuit of the statistical information acquisition device ST_AC.

FIG. 22 is a view illustrating the bit pattern of the operation output data, acquired by the statistical information acquisition device.

FIG. 23 is a view illustrating an example of a logic circuit of the statistical information aggregator ST_AGR_1.

FIG. 24 is a view illustrating an operation of the statistical information aggregator ST_AGR_1.

FIG. 25 is a view depicting an example of the second statistical information aggregator ST_AGR_2 and the statistical information register file.

FIG. 26 is a flowchart illustrating an example of the processing executed by the DL execution processor to calculate the mean,

FIG. 27 is a flowchart illustrating an example of the processing executed by the DL execution processor to calculate the variance.

### DESCRIPTION OF EMBODIMENTS

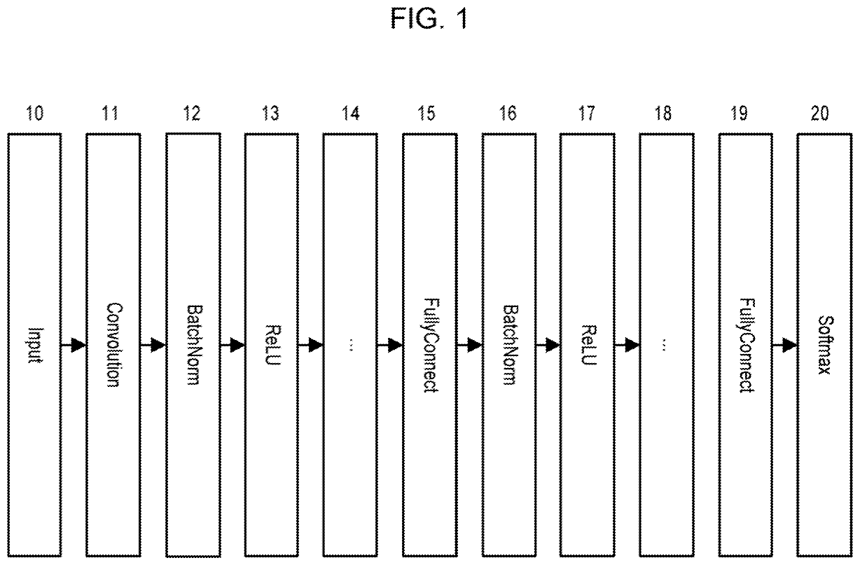

FIG. 1 is a view depicting an example configuration of a deep neural network (DNN). The DNN of FIG. 1 is an object category recognition model, for example, on which an image is input and the images are classified into a limited number of categories in accordance with the content (numerals, for example) of the input image. The DNN includes an input layer 10, a convolution layer 11, a batch normalization layer 12, an activation function layer 13, a hidden layer 14 such as a convolution layer, a fully connected layer 15, a batch normalization layer 16, an activation function layer 17, a hidden layer 18, a fully connected layer 19, and a softmax function layer 20. The softmax function layer 20 corresponds to an output layer. Each layer includes a single node or a plurality of nodes. A pooling layer may be inserted on the output side of the convolution layer.

The convolution layer 11 performs a multiply-and-accumulate operation including multiplying inter-node weights or the like and pixel data of an image input into the plurality of nodes in the input layer 10 and accumulating the multiplied values, for example, and outputs pixel data of an output image having the features of the image to each of a plurality of nodes in the convolution layer 11.

The batch normalization layer 12 normalizes the pixel data of the output image output to the plurality of nodes in the convolution layer 11 in order to suppress distribution bias, for example. The activation function layer 13 then inputs the normalized pixel data into an activation function and generates corresponding output. The batch normalization layer 16 performs a similar normalization operation as well.

As described above, by normalizing the distribution of the pixel data of the output image, bias in the distribution of the pixel data is corrected, and as a result, learning over the entire DNN proceeds efficiently.

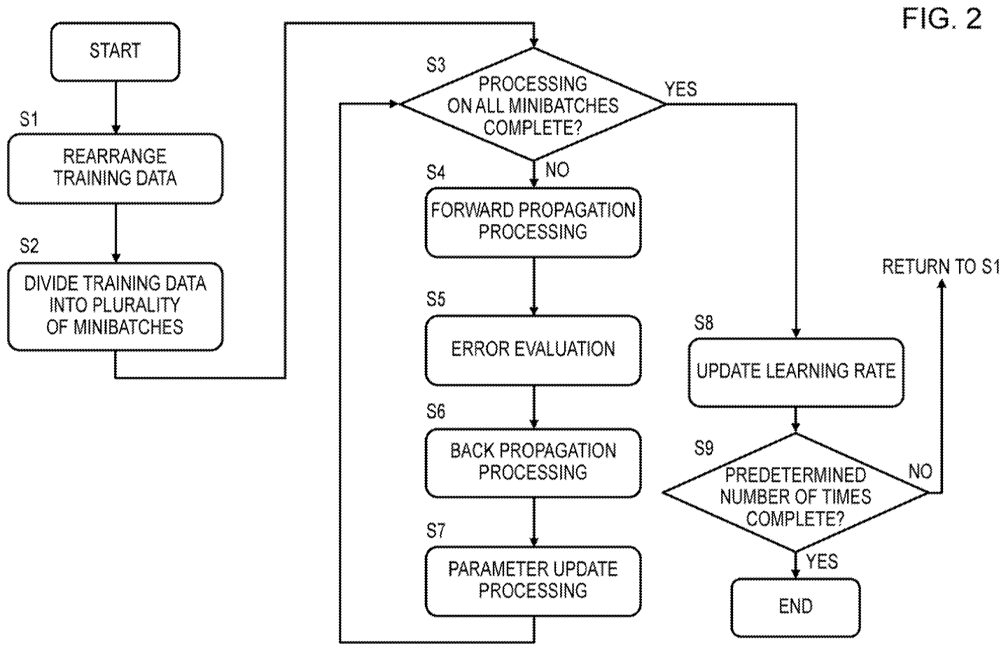

FIG. 2 is a view depicting a flowchart of an example of learning processing executed in the DNN. For example, in the learning processing, parameters such as weights in the DNN are optimized using a plurality of training data that include input data and correct data of an output calculated by inputting the input data into the DNN. In the example of FIG. 2, the plurality of training data are divided into a plurality of minibatches using a minibatch method, input data of the plurality of training data in each minibatch are input, and parameters such as weights are optimized so as to minimize the sum of squares of a difference (an error) between the output data output by the DNN in response to the input data and the correct data.

As illustrated in 2, as preparation, the plurality of training data are rearranged (S1) and the plurality of rearranged training data are divided into a plurality of minibatches (S2). Then, in the learning processing, forward propagation processing S4, error evaluation S5, backpropagation processing S6, and parameter update processing S7 are executed repeatedly on the plurality of divided minibatches (NO in S3). When processing of all of the minibatches is complete (YES in S3), a learning rate of the learning processing is updated (S8), whereupon the processing of S1 to S7 is executed repeatedly on the same training data until a specified number of times is reached (NO in S9).

Further, rather than repeating the processing of S1 to S7 on the same learning data until the specified number of times is reached, the learning processing is also terminated when an evaluation value of the learning result, for example the sum of squares of the difference (the error) between the output data and the correct data, converges on a fixed range.

In the forward propagation processing S4, operations are executed on each layer in order from the input side to the output side of the DNN. To illustrate this using FIG. 1 as an example, the convolution layer 11 performs a convolution operation on the input data of the plurality of training data which are input into the input layer 10 and included in one minibatch, using the weights of the edges, whereby a plurality of operation output data are generated. The normalization layer 12 then normalizes the plurality of operation output data in order to correct the distribution bias in the operation output data. Alternatively, when the hidden layer 14 is a convolution layer, a convolution operation is performed on the normalized plurality of operation output data in order to generate a plurality of operation output data, whereupon the batch normalization layer 16 performs normalization processing in a similar manner. The operations described above are executed from the input side to the output side of the DNN.

Next, in the error evaluation processing S5, the sum of squares of the difference between the output data of the DNN and the correct data is calculated as an error. The error is then backpropagated from the output side to the input side of the DNN (S6) In the parameter update processing S7, the weights and so on of each layer are optimized in order to minimize the backpropagated error of each layer. Optimization of the weights and so on is implemented by varying the weights and so on using a gradient descent method.

In the DNN, the plurality of layers may be formed from hardware circuits so that the operations of the respective layers are executed by the hardware circuits. Alternatively, the DNN may be formed by causing a processor to execute a program for executing the operations of the respective layers of the DNN.

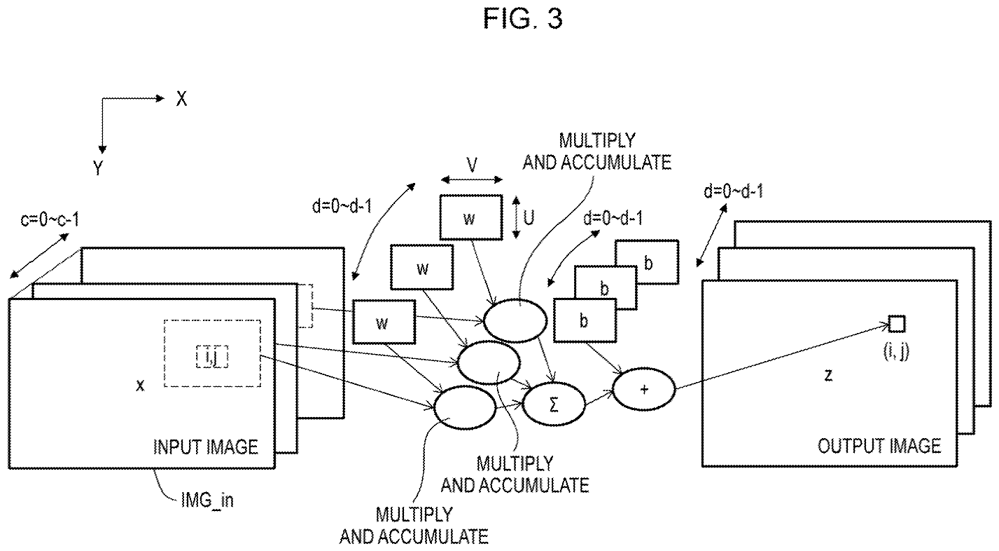

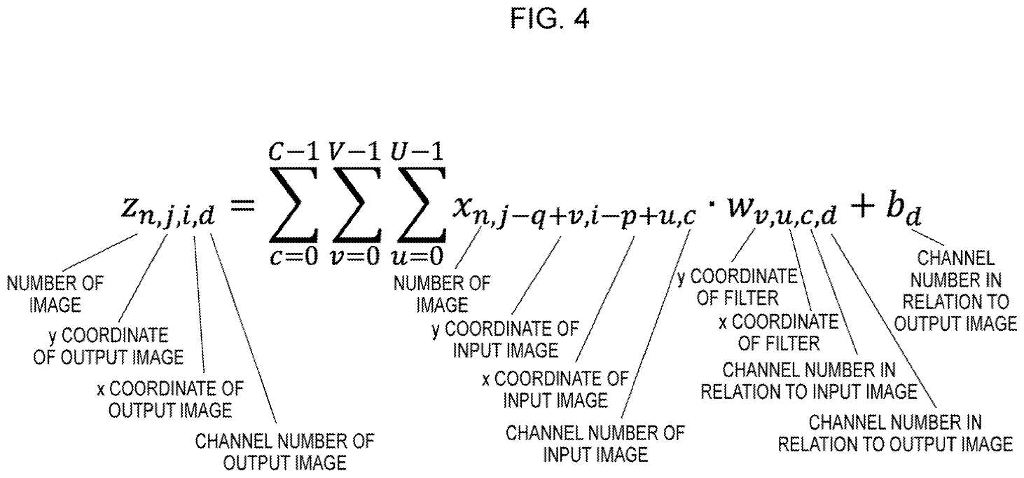

FIG. 3 is a view illustrating the operation performed on the convolution layer. FIG. 4 is a view depicting an arithmetic expression of the convolution operation. For example, in the operation performed on the convolution layer, an operation for convoluting a filter W with an input image IMG_in is performed, whereupon a bias b is added to the convoluted multiply-and-accumulate operation result. In FIG. 3, filters W are convoluted respectively with input images IMG_in on a C channel, biases b are added respectively thereto, and as a result, output images IMG_out on a D channel, o—d−1, are generated. Accordingly, the filter W and the bias b are each provided in a number corresponding to the D channel.

According to the convolution arithmetic expression depicted in FIG. 4, a multiply-and-accumulate operation is performed, in a number corresponding to the filter size V*U and the number of channels C, between a pixel value x_{n, j-q+v, i-p+u, c} at coordinates (V, X)=(j−q+v, i−p+u) on a channel c corresponding to an image number n and the pixel value (the weight) w_{v, u, c, d} of the filter W, whereupon the bias b_{d} is added thereto and a pixel value z_{n, j, i, d} at coordinates (j, i) of an output image IMG_out corresponding to a channel number d is output. In other words, images having image numbers n include images corresponding to the number of channels C, and in the convolution operation, multiply-and-accumulate operations are performed, for each image number n, on the two-dimensional pixels of each channel in accordance with the number of channels C, whereupon output images having image numbers n are generated. Further, when the filter w and the bias b are provided in a number corresponding to the plurality of channels d, the output images having the image numbers n include images in a number corresponding to the plurality of channels d.

Input images are input into the input layer of the DNN in a number corresponding to the number of channels C, and as a result of the operation performed on the convolution layer, output images are output in a number corresponding to the number of filters d and the number of biases d. Similarly, on a convolution layer provided on an intermediate layer of the DNN, images are input into the preceding layer in a number corresponding to the number of channels C, and as a result of the operation performed on the convolution layer, output images are output in a number corresponding to the number of filters d and the number of biases d.

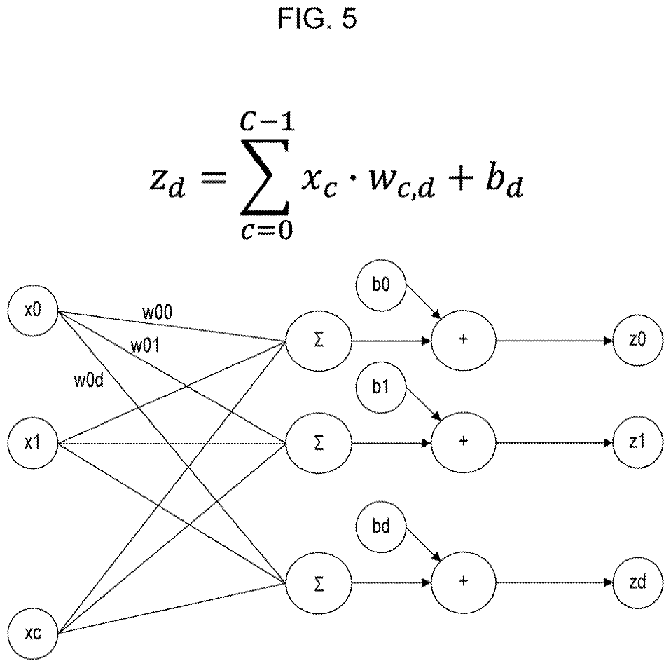

FIG. 5 is a view illustrating the operation performed on the fully connected layer. The fully connected layer connects all of the nodes x0-xc on the input-side layer to all of the nodes z0-zd on the output-side layer, performs a multiply-and-accumulate operation between the values x0-xc of all of the nodes on the input-side layer and the weights w_{c, d} of the edges of the respective connections, adds the biases b_{d} respectively thereto, and outputs values z0-zc of all of the nodes on the output-side layer.

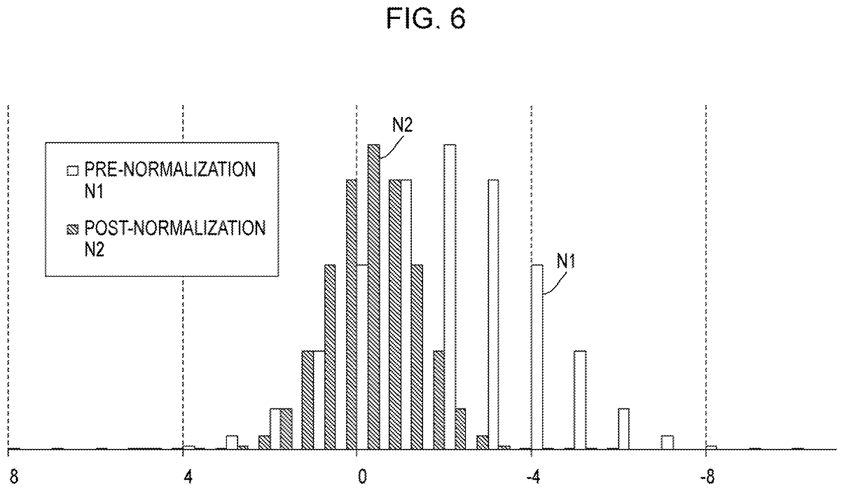

FIG. 6 is a view illustrating normalization on the batch normalization layer. FIG. 6 depicts a pre-normalization histogram N1 and a post-normalization histogram N2. On the pre-normalization histogram N1, the distribution is biased on the left side of the center 0, but on the post-normalization histogram N2, the distributions on the left and right sides of the center 0 are symmetrical.

In the DNN, the normalization layer is a layer for normalizing the plurality of output data from the layer prior to the normalization layer on the basis of the mean and the variance thereof. In the normalization of the example depicted in FIG. 6, the mean is scaled to 0 and the variance is scaled to 1. The batch normalization layer calculates the mean and the variance of the plurality of output data for each minibatch that is a learning processing unit of the DNN and normalizes the plurality of output data on the basis of the mean and the variance.

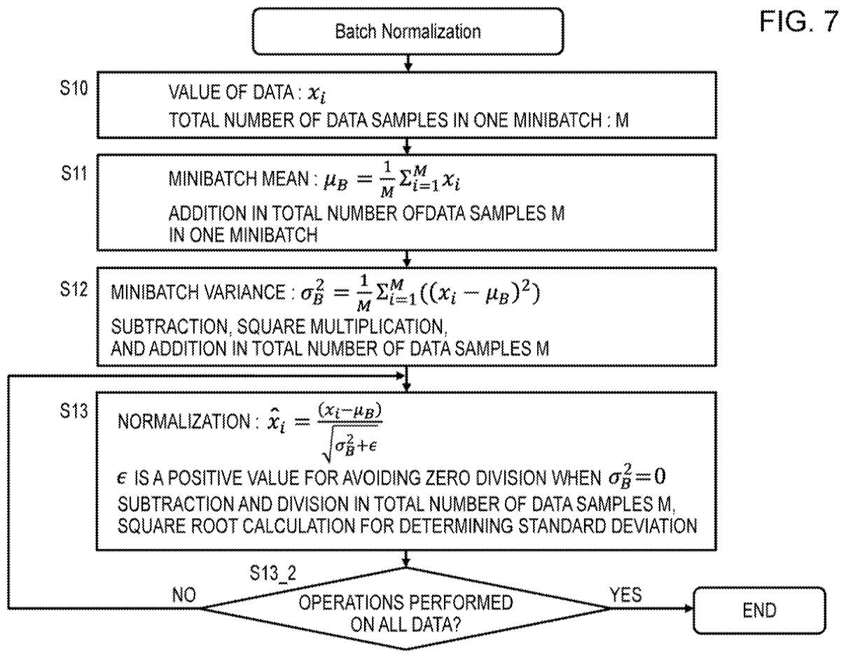

FIG. 7 is a view depicting a flowchart of a minibatch normalization operation. The normalization operation of FIG. 7 is an example of divisive normalization. Instead of divisive normalization, the normalization operation may be subtractive normalization, in which the mean of the output data is subtracted from the output data.

In FIG. 7, the learning data are divided into a plurality of minibatches. The value of operation output data of the convolution operation performed in the minibatch is set as xᵢ, and the total number of samples of operation output data in one minibatch is set as M (S10). In the normalization operation of FIG. 7, first, all of the data xᵢ (i=1 to M) in one subject minibatch are added together and divided by the number of data samples M to determine a mean (S11). In the operation S11 to determine the mean, addition in M times in accordance with the total number of data samples M in one minibatch, and one division by M is necessary. Next, in the normalization operation, the square of a difference acquired by subtracting the mean μ_{B} from the value xᵢ of each data sample is determined, and by cumulatively adding the values of the squares, a variance σ²_{B} is determined (S12). In this operation, subtraction, multiplication of squares, and addition each in M times in accordance with the total number of data samples M are necessary. Then, on the basis of the mean μ_{B} and the variance σ²_{B} described above, all of the output data are normalized by the operations depicted in the figure (S13, S13_2). In this normalization operation, subtraction, division, and square root calculation for determining a standard deviation each in M times, in accordance with the total number of data samples M, are necessary.

Hence, during batch normalization, a large number of operations are performed, leading to an increase in the overall number of learning operations. For example, when the number of output data samples is M, addition (including subtraction) is performed M times and division is performed once in the operation for determining the mean. Further, in the operation for determining the variance, addition is performed 2M times, multiplication is performed M times, and division is performed once. Then, to normalize the M samples of output data on the basis of the mean and the variance, subtraction and division are each performed M times, while square root determination is performed once.

Further, when the image size is H×H, the number of channels is D, and the number of images in the batch is K, the total number of output data samples to be normalized is H*H*D*K, leading to a dramatic increase in the number of the operations described above.

Note that normalization processing may be performed on the input data of the learning data as well as on the output data of the convolution layer of the DNN and so on. In this case, the total number of input data samples is H*H*C*K, which is a number acquired by multiplying the number of pixels H*H of a number of input images corresponding to the number of channels C of the training data by the number of training data samples K.

In this embodiment, either operation output data generated by an arithmetic unit or normalization subject data such as input data will be referred to as subject data. In this embodiment, statistical information about the subject data is acquired in order to simplify the normalization operation.

### Embodiment

An embodiment described below relates to a method for reducing the number of operations performed during normalization.

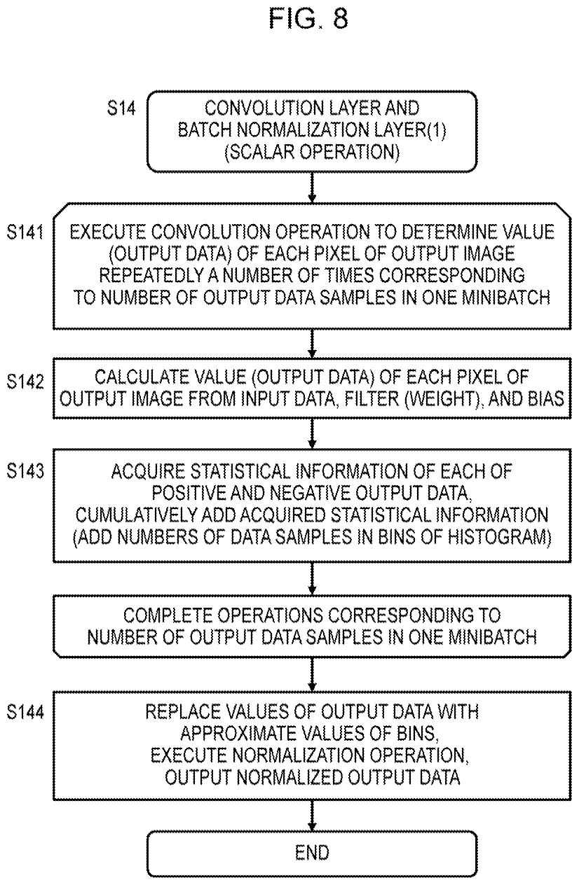

FIG. 8 is a flowchart depicting processing performed on a convolution layer and a batch normalization layer (1) according to this embodiment. This processing is executed by a deep learning (DL) execution processor. The deep learning is performed using a DNN. Further, in the example of FIG. 8, the deep learning is executed by a scalar arithmetic unit inside the DL execution processor.

In the operation S14 performed on the convolution layer and the batch normalization layer, a convolution operation for determining the value (the output data) of each pixel of all of the output images in one minibatch is repeated a number of times corresponding to the number of output data samples in one minibatch (S141). Here, the number of output data (samples) in one minibatch is the number of pixels in all of the output images generated from the input images of the plurality of training data in one minibatch.

First, the scalar arithmetic unit provided in the DL execution processor executes a convolution operation between an input data sample, which is a pixel value of an input image, and the weight of a filter using a bias, thereby calculating the value (the operation output data) of one pixel of the output image (S142). Next, the DL execution processor acquires statistical information relating to positive operation output data and negative operation output data and adds the acquired positive and negative statistical information respectively to cumulative addition values of acquired positive and negative statistical information (S143). The convolution operation S142 and the operation S143 for acquiring and cumulatively adding the statistical information described above are performed by hardware such as the scalar arithmetic unit of the DL execution processor on the basis of a DNN operation program.

Once the processing of S142, S143 has been performed a number of times corresponding to the number of output data (samples) in one minibatch, the DL execution processor replaces the respective values of the operation output data with approximate values of respective bins of the statistical information, executes a normalization operation, and outputs the normalized output data (S144). Since the values of the operation output data belonging to the same bin are replaced with an approximate value of the corresponding bin, the mean and the variance of the output data, which are used during normalization, can be calculated easily on the basis of the approximate values and the number of data samples belonging to the bins. The processing of S144 constitutes the operation performed on the batch normalization layer.

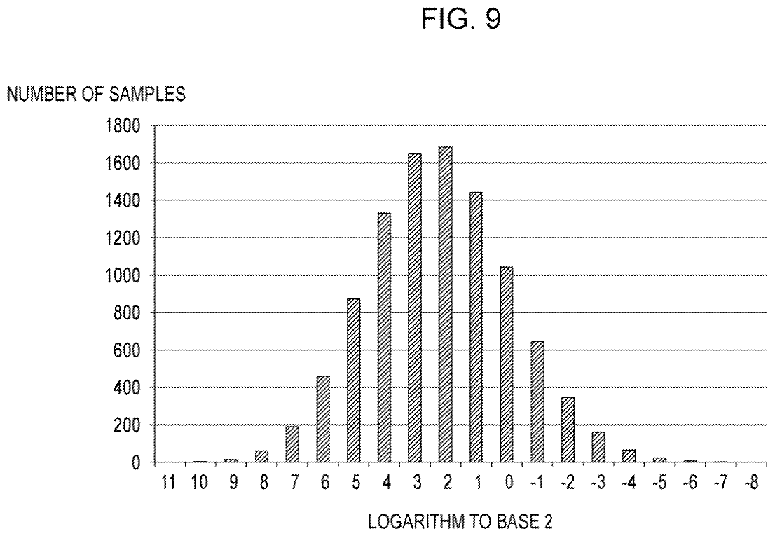

FIG. 9 is a view illustrating the statistical information. The statistical information of the operation output data corresponds to the number of bins on a histogram based on a logarithm (log₂X) of operation output data X to base 2. In this embodiment, as described above in relation to the processing of S143, the operation output data are divided into positive numbers and negative numbers, and in relation to these respective data sets, the number of bins on the histogram is cumulatively added. When the operation output data X have a binary number, the logarithm (log₂X) of the operation output data X to base 2 denotes the number of digits (the number of bits) of the output data X. Accordingly, when the output data X are a binary number having 20 bits, the histogram has 20 bins. FIG. 9 depicts this example.

FIG. 9 depicts an example of the histogram of the positive or negative operation output data. In the plurality of bins on the histogram, the horizontal axis corresponds to the logarithm (log₂X) of the output data X to base 2 (the bit number of the output data), and the number on the vertical axis corresponds to the number of samples in each bin (the number of operation output data samples). Negative values on the horizontal axis correspond to a position of a leftmost set bit for positive number or a position of a leftmost zero bit for negative number at or below the decimal point of the operation output data, while positive values on the horizontal axis correspond to a position of a leftmost set bit for positive number or a position of a leftmost zero bit for negative number of the integer portion of the operation output data. The leftmost set bit for positive number means a leftmost “1” bit for positive number (the sign bit is “0”) and the leftmost zero bit for negative number means a leftmost “0” bit for negative number (the sign bit is “1”). For example, when the positive number is 0010 (=+010), the leftmost set bit is the second bit from the least significant bit. When the negative number is 1010 (=−110), the left most zero bit is the third bit from the least significant bit.

For example, 20 (−8 to +11), which is the number of bins on the horizontal axis, corresponds to 20 bits of binary operation output data. Data samples within “0 0000 0000 1000.0000 0000 to 0 0000 0000 1111.1111 1111”, among operation output data (a fixed-point number) to which a sign bit has been added, are included in bin number “3” on the horizontal axis. In this case, the position of the leftmost set bit for positive number or the leftmost zero bit for negative number of the operation output data corresponds to “3”. For example, an approximate value of the operation output data in bin number “3” is 2³ (=8 in base 10), i.e., the minimum value of “0 0000 0000 1000.0000 0000 to 0 0000 0000 1111.1111 1111”.

The leftmost set bit for positive number or the leftmost zero bit for negative number may called as the leftmost non-sign bit. Here, the non-sign bit denotes either 1 or 0 in contrast to a sign bit of 0 (positive) or 1 (negative). In a positive number, the sign bit is 0, and therefore the non-sign bit is 1. In a negative number, the sign bit is 1, and therefore the non-sign bit is 0. The non-sign bit is a bit different from the sign bit.

When the operation output data are expressed as a fixed-point number, each of the bins on the horizontal axis of the histogram corresponds to a position of the leftmost set bit for positive number or the leftmost zero bit for negative number. In this case, the bin to which each operation output data sample belongs can easily be detected simply by detecting the leftmost set bit for positive number or the leftmost zero bit for negative number of the operation output data sample. When the operation output data are expressed as a floating-point number, on the other hand, each of the bins on the horizontal axis of the histogram corresponds to the value (the number of digits) of the significand. In this case also, the bin to which each operation output data sample belongs can easily be detected.

In this embodiment, the number of samples (or data) in each bin on the histogram, corresponding to the digits of the output data, as illustrated in FIG. 9, is acquired as the statistical information, and the mean and variance of the output data, which are used in the normalization processing, are determined using the approximate value of each bin and the statistical information (the number of samples (or data) in each bin). More specifically, the output data belonging to each bin are approximated to an approximate value of +2^{e+i} when the sign bit is positive and −2^{e+i} when the sign bit is negative. “e” is a scale of the output data. Here, i denotes the bit position of the leftmost set bit for positive number or the leftmost zero bit for negative number, or in other words the value on the horizontal axis of the histogram. By approximating the output data belonging to the bins to the aforesaid approximate values, the operations for determining the average and the variance can be simplified. As a result, the load on the processor during the normalization processing can be lightened, enabling reductions in the learning processing load and the learning time.

When the output data samples belonging to bin “3” of the histogram depicted in FIG. 9 are all approximated to an approximate value 2³, the sum of the values of the output data samples belonging to bin 3, assuming that the number of data samples belonging to the bin is 1647, can be determined by the following operation.

Σ(2³=<X<2⁴)=1647*2³

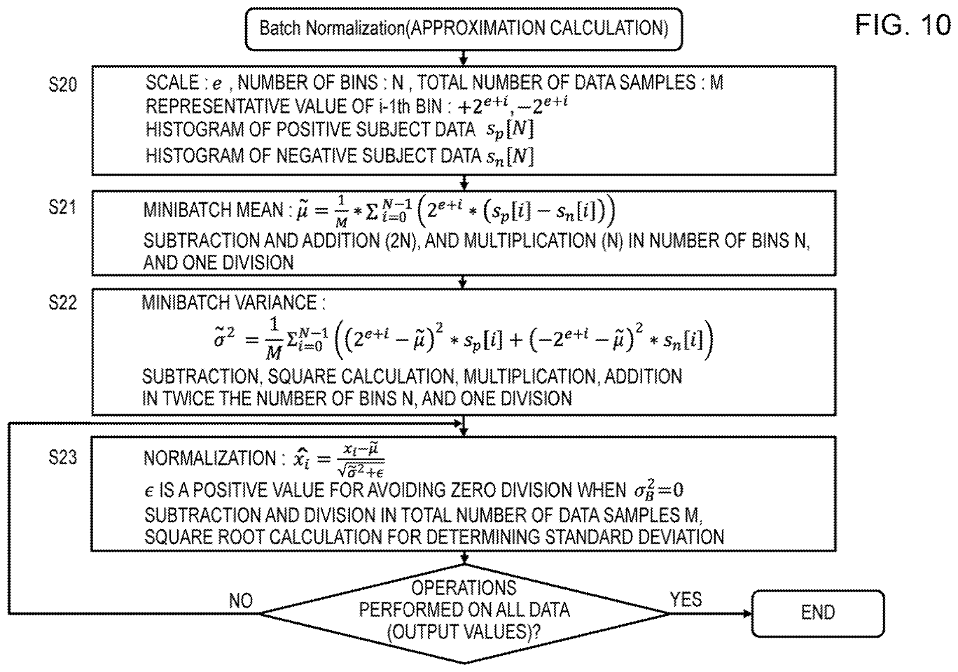

FIG. 10 is a view depicting a flowchart of the batch normalization processing according to this embodiment. First, the statistical information of the histogram is input into the processor for executing batch normalization as an initial value (S20). The statistical information is constituted by a scale (the exponent of the value of the smallest bit) e of the histogram, the number of bins N, the total number of samples of the output data M, the positive and negative approximate values +2^{e+i} and −2^{e+i} of an i−1^{th} bin, respective histograms (numbers of data (or samples) belonging to the bins) Sₚ[N], Sₙ[N] of the positive and negative subject data, and so on.

The histogram (the numbers of data (or samples) belonging to the bins) Sₚ[N] of the positive subject data denotes the number of data (or samples) belonging to

2^{e+i}≤X<2^{e+i+1},

Further, the histogram (the numbers of data (or samples) belonging to the bins) Sₙ[N] of the negative subject data denotes the number of data samples belonging to

−2^{e+i+1}<X≤−^{e+i},

Next, the processor determines the mean of the minibatch of data (S21). An arithmetic expression for determining the mean μ is illustrated in S21 of FIG. 10. In this arithmetic expression, the result of subtracting the respective histograms (the numbers of data samples belonging to the bins) Sₚ[N], Sₙ[N] of the positive and negative subject data and multiplying the approximate value 2^{e+i} thereby is added in accordance with the number of bins N in one minibatch and finally divided by the total number of samples M. Hence, the processor performs addition (including subtraction) corresponding to the number of bins N in one minibatch twice (2N additions), multiplication once (N multiplications), and division once.

The processor also determines the variance σ² of the minibatch of data (S22). An arithmetic expression for determining the variance is illustrated in S22 of FIG. 10. In this arithmetic expression, the result of subtracting the mean μ from the positive approximate value 2^{e+i} and squaring the result is multiplied by the number of data (or samples) Sₚ[N] in the bin, and similarly, the result of subtracting the mean μ from the negative approximate value −2^{e+i} and squaring the result is multiplied by the number of data (or samples) Sₙ[N] in the bin. The two results are then added together and accumulated. Finally, the result is divided by the total number of data samples M. Hence, the processor performs addition/subtraction 4N times, multiplication 4N times, and division once.

The processor then normalizes the subject data xᵢ on the basis of the mean μ and the variance σ² using the arithmetic expression illustrated in S23 of FIG. 10 (S23, S24). Subtraction, division, and square root calculation to determine the standard deviation from the variance are performed to normalize the data xᵢ, and therefore the processor performs subtraction, division, and square root calculation N times each.

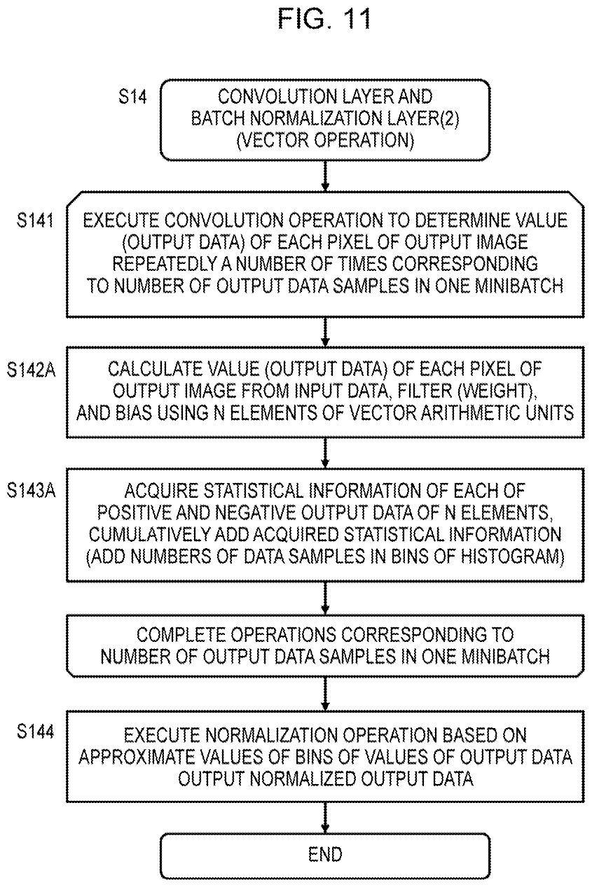

FIG. 11 is a view depicting a flowchart on which the processing of the convolution layer and the batch normalization layer according to this embodiment is performed by a vector arithmetic unit. In contrast to the processing performed by the scalar arithmetic unit, illustrated in FIG. 8, in processing of S142A, each of N elements of the vector arithmetic unit calculates the value (the output data) of each pixel of the output image from the input data, the weight of the filter, and the bias. Similarly, in processing of S143A, statistical information about the output data calculated respectively by the N elements of the vector arithmetic unit is acquired, and the acquired statistical information is cumulatively added together. Apart from being performed by a vector arithmetic unit, the processing of S142A and S143A is identical to the processing of S142 and S143 in FIG. 8.

Hence, in FIG. 11, the N elements of the vector arithmetic unit execute the operations of the processing of S142A, S143A in parallel, and therefore the operation time is shorter than the operation time of the operation performed by the scalar arithmetic unit in FIG. 8.

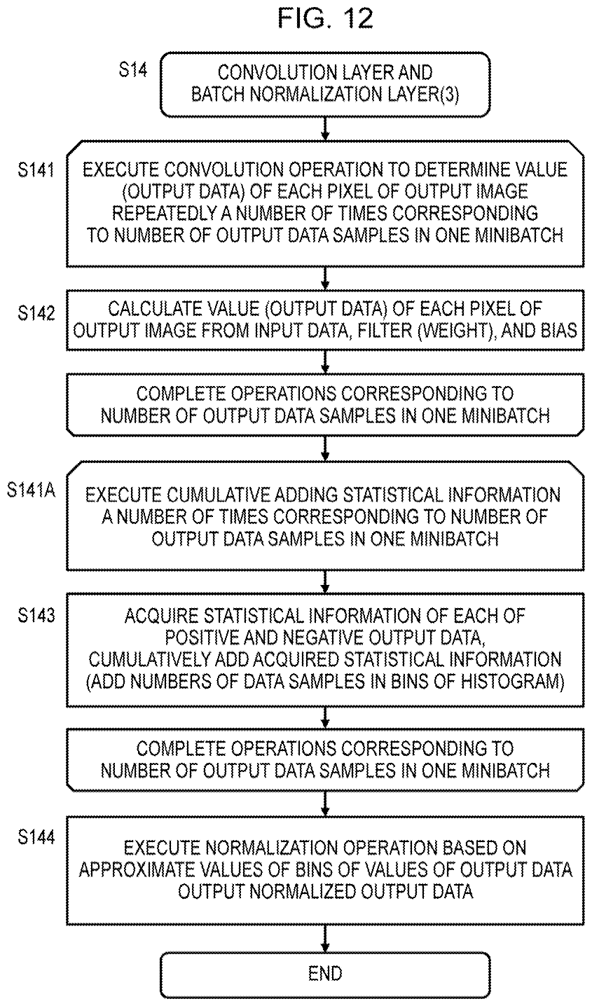

FIG. 12 is a view depicting a flowchart on which the processing of the convolution layer and the processing of the batch normalization layer according to this embodiment are performed separately. FIG. 12, similarly to FIG. 8, is an example in which the operations are performed by a scalar arithmetic unit.

In FIG. 12, in contrast to FIG. 8, during the processing of S141 and S142, the processor repeats the convolution operation for determining the value (the output data) of each pixel of the output image a number of times corresponding to the number of output data in one minibatch. These output data are respectively stored in a memory. Next, in processing of S141A and S143, the processor reads the output data stored in the memory, acquires statistical information about the output data, cumulatively adds the statistical information, and stores the statistical information in a register or a memory. Finally, in processing of S144, the processor replaces the values of the output data with approximate values of the bins, executes a normalization operation, and outputs the normalized output data. The normalized output data are stored in a memory. The processing of S142, S143, and S144, described above, is identical to that of FIG. 8.

As illustrated in FIG. 11, the convolution operation processing of S142 in FIG. 12 may be performed by N elements of a vector arithmetic unit in parallel. In this case, during the processing of S143, statistical information is acquired from the output data of the convolution operation, output respectively by the N elements of the vector arithmetic unit, whereupon the statistical information is aggregated and cumulatively added,

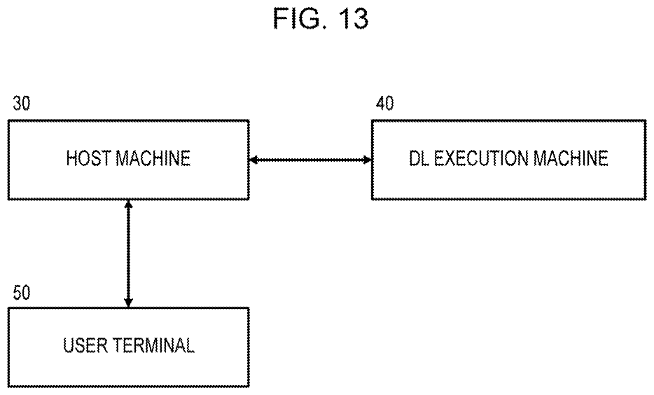

FIG. 13 is a view depicting an example configuration of the deep learning (DL) system according to this embodiment. The DL system includes a host machine 30 and a DL execution machine 40, the host machine 30 and the DL execution machine 40 being connected by a dedicated interface, for example. Further, a user terminal 50 is capable of accessing the host machine 30 so that a user executes deep learning by accessing the host machine 30 from the user terminal 50 and operating the DL execution machine 40. The host machine 30 creates a program to be executed by the DL execution machine in response to an instruction from the user terminal and transmits the created program to the DL execution machine. The DL execution machine executes deep learning by executing the transmitted program.

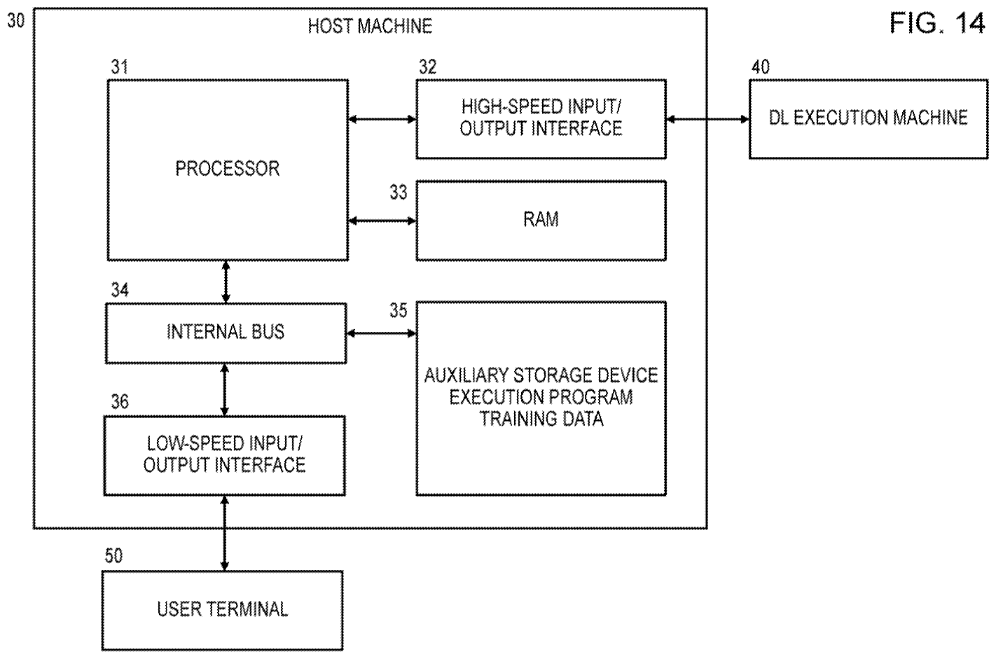

FIG. 14 is a view depicting an example configuration of the host machine 30. The host machine 30 includes a processor 31, a high-speed input/output interface 32 for establishing a connection with the DL execution machine 40, a main memory 33, and an internal bus 34. The host machine 30 further includes an auxiliary storage device 35, such as a large-capacity HDD, connected to the internal bus 34, and a low-speed input/output interface 36 for establishing a connection with the user terminal 50.

The host machine 30 executes a program acquired by expanding a program stored in the auxiliary storage device 35 to the main memory 33, As illustrated in the figure, a DL execution program and training data are stored in the auxiliary storage device 35. The processor 31 transmits the DL execution program and the training data to the DL execution machine so as to cause the DL execution machine to execute the program.

The high-speed input/output interface 32 is an interface such as a PCI Express for connecting the processor 31 to hardware of the DL execution machine. The main memory 33 is an SDRAM, for example, that stores a program executed by the processor and data.

The internal bus 34 connects a peripheral device having a lower speed than the processor to the processor in order to relay communication therebetween. The low-speed input/output interface 36 is an interface such as a USB, for example, for establishing a connection with a keyboard or a mouse of the user interface or establishing a connection with an Internet network.

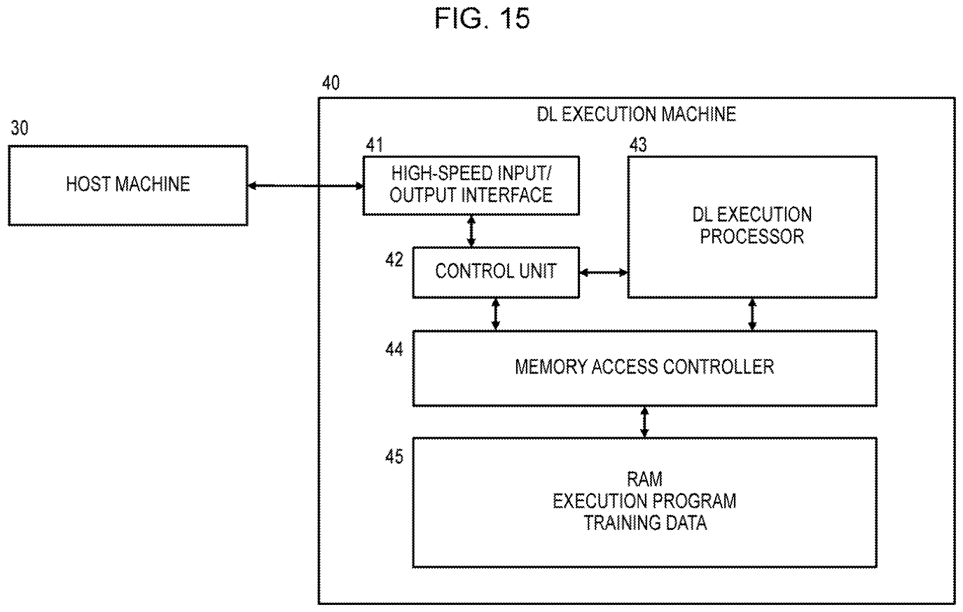

FIG. 15 is a view depicting an example configuration of the DL execution machine. The DL execution machine 40 includes a high-speed input/output interface 41 for relaying communication with the host machine 30, and a control unit 42 for executing corresponding processing on the basis of instructions and data from the host machine 30. The DL execution machine 40 further includes a DL execution processor 43, a memory access controller 44, and an internal memory 45.

The DL execution processor 43 executes deep learning processing by executing a program on the basis of the DL execution program and data transmitted from the host machine. The high-speed input/output interface 41 is a PCI Express, for example, for relaying communication with the host machine 30.

The control unit 42 stores the program and data transmitted from the host machine in the memory 45 and, in response to an instruction from the host machine, instructs the DL execution processor to execute the program. The memory access controller 44 controls processing for accessing the memory 45 in response to an access request from the control unit 42 and an access request from the DL execution processor 43.

The internal memory 45 stores the program executed by the DL execution processor, processing subject data, processing result data, and so on. The internal memory 45 is an SDRAM, a high-speed GDR5, a broadband HBM2, or the like, for example.

As illustrated in FIG. 14, the host machine 30 transmits the DL execution program and the training data to the DL execution machine 40. The execution program and the training data are stored in the internal memory 45. Then, in response to an execution instruction from the host machine 30, the DL execution processor 43 of the DL execution machine 40 executes the execution program.

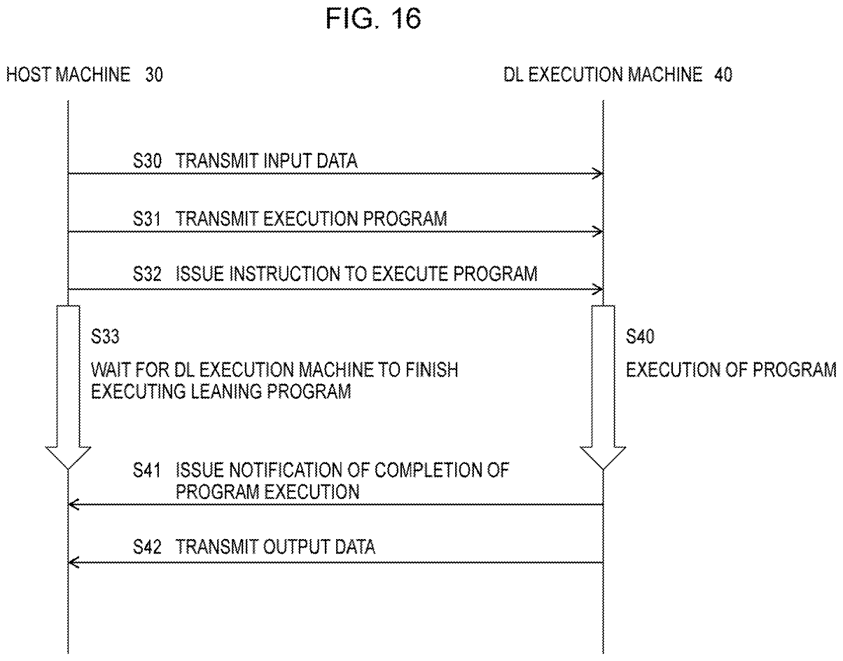

FIG. 16 is a schematic view of a sequence chart of the deep learning processing executed by the host machine and the DL execution machine. The host machine 30 transmits the input data of the training data (S30), the deep learning execution program (the learning program) (S31), and a program execution instruction (S32) to the DL execution machine 40.

In response to the transmissions, the DL execution machine 40 stores the input data and the execution program in the internal memory 45, and in response to the program execution instruction, the DL execution machine 40 executes the execution program (the learning program) on the input data stored in the memory 45 (S40). In the meantime, the host machine 30 waits for the DL execution machine to finish executing the learning program (S33).

After completing execution of the deep learning program, the DL execution machine 40 transmits a notification of the completion of program execution to the host machine 30 (S41) and transmits the output data to the host machine 30 (S42). When the output data are output data from the DNN, the host machine 30 executes processing for optimizing the parameters (the weights and so on) of the DNN in order to reduce the error between the output data and the correct data. Alternatively, in a case where the DL execution machine 40 executes the processing for optimizing the parameters of the DNN so that the output data transmitted by the DL execution machine include the optimized DNN parameters (weights and so on), the host machine 30 stores the optimized parameters.

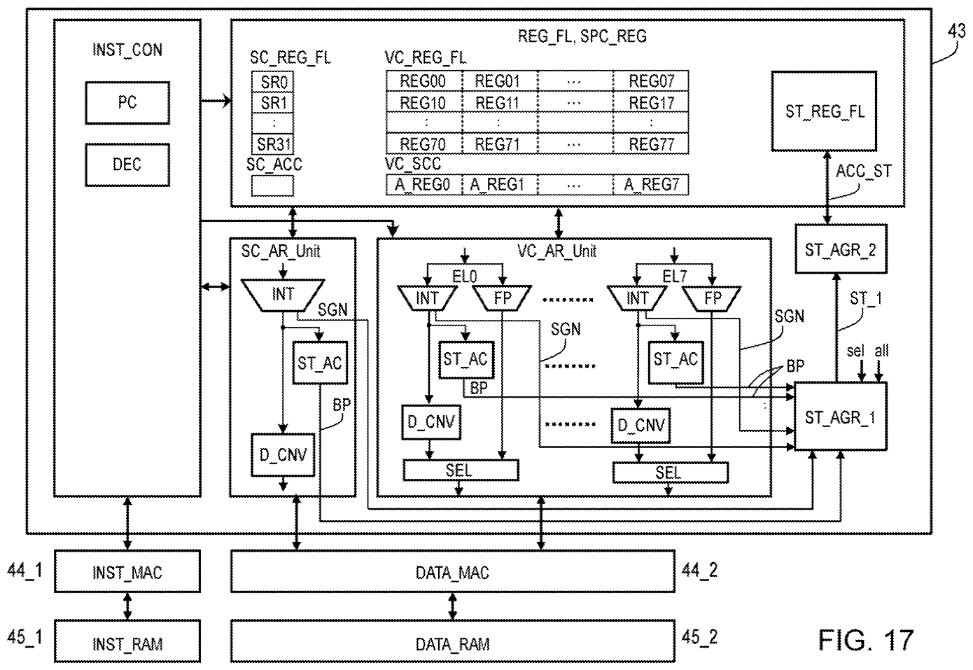

FIG. 17 is a view depicting an example configuration of the DL execution processor 43. The DL execution processor, or the DL execution arithmetic processing device 43, includes an instruction control unit INST_CON, a register file REG_FL, a special register SPC_REG, a scalar arithmetic unit or circuit SC_AR_UNIT, a vector arithmetic unit or circuit VC_AR_UNIT, and statistical information aggregators or aggregation circuits ST_AGR_1, ST_AGR_2.

Further, an instruction memory 45_1 and a data memory 45_2 are connected to the DL execution processor 43 via the memory access controller (MAC) 44. The MAC 44 includes an instruction MAC 44_1 and a data MAC 44_2.

The instruction control unit INST_CON includes a program counter PC, an instruction decoder DEC, and so on, for example. The instruction control unit fetches an instruction from the instruction memory 45_1 on the basis of an address in the program counter PC, whereupon the instruction decoder DEC decodes the fetched instruction and issues the decoded instruction to an arithmetic unit.

The scalar arithmetic unit SC_AR_UNIT includes a group formed from an integer arithmetic unit INT, a data converter D_CNV, and a statistical information acquisition device ST_AC. The data converter converts fixed-point number output data output by the integer arithmetic unit INT to a floating-point number. The scalar arithmetic unit SC_AR_UNIT executes an operation using scalar registers SR0-SR31 in a scalar register file SC_REG_FL and a scalar accumulate register SC_ACC. For example, the integer arithmetic unit. INT calculates the input data stored in one of the scalar registers SR0-SR31 and stores the resulting output data in a different register. Further, when executing a multiply-and-accumulate operation, the integer arithmetic unit INT stores the multiply-and-accumulate result in the scalar accumulate register SC_ACC.

The register file REG_FL includes the aforementioned scalar register file SC_REG_FL and scalar accumulate register SC_ACC used by the scalar arithmetic unit SC_AR_UNIT. The register file REG_FL also includes a vector register file VC_REG_FL and a vector accumulate register VC_ACC used by the vector arithmetic unit VC_AR_UNIT.

The scalar register file SC_REG_FL includes the scalar registers SR0-SR31, each of which has 32 bits, for example, and the scalar accumulate registers SC_ACC, each of which has 32×2 bits+α bits, for example.

The vector register file VC_REG_FL includes eight sets REG11-REG07 to REG70-REG77 of 32-bit registers REGn0-REGn7, each register having eight elements, for example. Further, the vector accumulate register VC_ACC includes registers A_REG0 to A_REG7 constituting eight elements, each element having 32×2 bits+α bits, for example.

The vector arithmetic unit VC_AR_UNIT includes arithmetic units EL0-EL7 constituting eight elements. Each element EL0-EL7 includes an integer arithmetic unit INT, a floating point arithmetic unit FP, and a data converter D_CNV. For example, the vector arithmetic unit inputs the registers REGn0-REGn7 constituting the eight elements of one of the sets in the vector register file VC_REG_FL, whereupon operations are executed in parallel by the arithmetic units of the eight elements and the operation results are stored in the registers REGn0-REGn7 constituting the eight elements of another set.

Further, the vector arithmetic unit executes multiply-and-accumulate operations using the arithmetic units of the eight elements and stores multiply-and-accumulate values that are the multiply-and-accumulate results in the registers A_REG0 to A_REG7 constituting the eight elements of the vector accumulate register VC_ACC.

The number of arithmetic unit elements in the vector registers REGn0-REGn7 and the vector accumulate registers A_REG0 to A_REG7 is increased to 8, 16, or 32 elements in accordance with whether the number of bits of the operation subject data is 32, 16, or 8 bits.

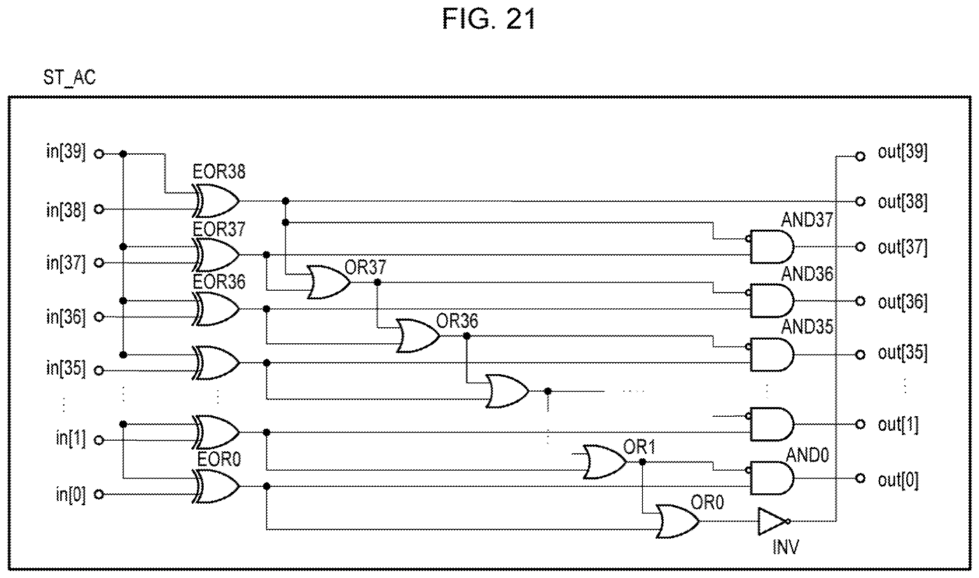

The vector arithmetic unit includes eight statistical information acquisition devices or circuits ST_AC for respectively acquiring statistical information about the output data from the integer arithmetic units INT of the eight elements. The statistical information is information indicating the positions of the leftmost set bit for positive number or the left most zero bit for negative number in the output data of the integer arithmetic units INT. The statistical information is acquired in the form of a bit pattern to be described below using FIG. 21.

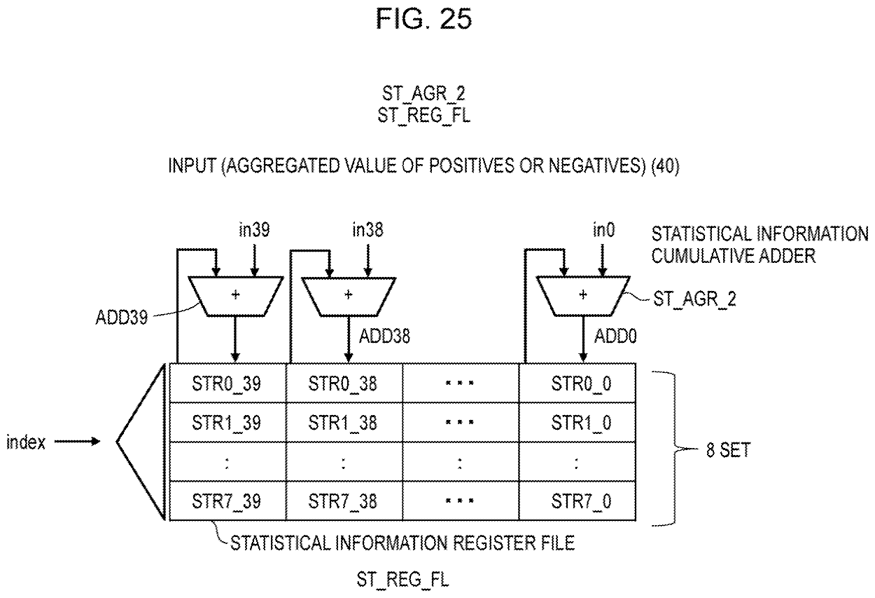

As illustrated in FIG. 25, to be described below, a statistical information register file ST_REG_FL includes, for example, eight sets STR0_0-STR0_39 to STR7_0-STR7_39 of statistical information registers STR0-STR39 constituting 32 bits×40 elements, for example.

Addresses, the parameters of the DNN, and so on, for example, are stored in the scalar registers SR0-SR31. Further, operation data from the vector arithmetic units are stored in the vector registers REG00-REG07 to REG70-REG77. Multiplication results and addition results between vector registers are stored in the vector accumulate register VC_ACC. Numbers of data (or samples) belonging to pluralities of bins of a maximum of eight types of histograms are stored in the statistical information registers STR0_0-STR0_39 to STR7_0-STR7_39 shown in FIG. 25. When the output data from the integer arithmetic units INT have 40 bits, numbers of data samples belonging to bins corresponding respectively to the 40 bits are stored in the statistical information registers STR0_0-STR0_39, for example.

The scalar arithmetic unit SC_AR_UNIT executes arithmetic operations, shift operations, bifurcation, loading and storage, and so on. As described above, the scalar arithmetic unit includes the statistical information acquisition device ST_AC for acquiring statistical information including the positions of the bins of the histogram from the output data of the integer arithmetic unit INT.

The vector arithmetic unit VC_AR_UNIT executes floating point operations, integer operations, multiply-and-accumulate operations using the vector accumulate register, and so on. Further, the vector arithmetic unit executes operations to clear the vector accumulate register, multiply-and-accumulate (MAC) operations, cumulative addition, transfer to the vector registers, and so on. The vector arithmetic unit also executes loading and storage. As described above, the vector arithmetic unit includes the statistical information acquisition device SLAC for acquiring statistical information including the positions of the bins of the histogram from the output data of the respective integer arithmetic units INT of the eight elements.

Convolution and Normalization Operations Executed by DL Execution Processor

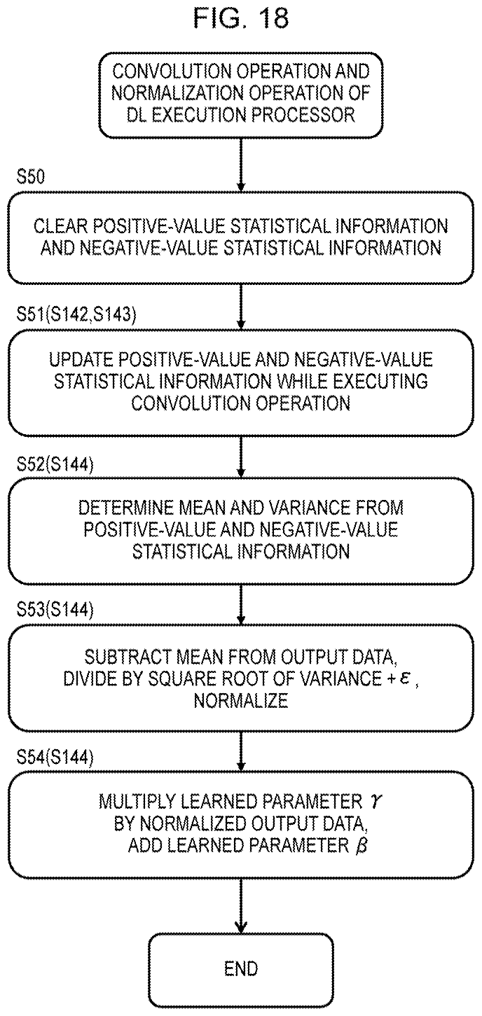

FIG. 18 is a view depicting a flowchart of the convolution and normalization operations executed by DL execution processor of FIG. 17. FIG. 18 illustrates in more detail the processing performed during the normalization operation S144 in the processing of FIGS. 8 and 11.

The DL execution processor clears the positive-value statistical information and negative-value statistical information stored in the register sets in the statistical information register file ST_REG_FL (S50). The DL execution processor then updates the positive-value statistical information and negative-value statistical information of the convolution operation output data while forward-propagating through the plurality of layers of the DNN, for example while executing a convolution operation (S51).

The convolution operation is executed by, for example, the integer arithmetic units INT of the eight elements in the vector arithmetic unit and the vector accumulate register VC_ACC. The integer arithmetic units INT repeatedly execute the multiply-and-accumulate operation of the convolution operation and store the resulting operation output data in the accumulate register. The convolution operation may also be executed by the integer arithmetic unit INT in the scalar arithmetic unit SC_AR_UNIT and the scalar accumulate register SC_ACC.

The statistical information acquisition device ST_AC outputs a bit pattern indicating the bit positions of the leftmost set bit for positive number or the leftmost zero bit for negative number in the output data of the convolution operation, output from the integer arithmetic unit INT. Further, the statistical information aggregators ST_AC_1, ST_AC_2 add together the numbers of leftmost set bits for positive values at every bit positions of the operation output data, add together the numbers of the leftmost zero bits for negative values at every bit positions of the operation output data, and store the resulting cumulative addition values in one set of registers STRn_0-STRn_39 in FIG. 25 in the statistical information register file ST_REG_FL. The one set of registers are constituted by a number of registers corresponding to the total number of bits of the output data of the convolution operation, and a specific example thereof will be described below using FIG. 25.

Next, the DL execution processor executes normalization operations of S52, S53, S54. The DL execution processor determines the mean and the variance of the operation output data from the positive-value and negative-value statistical information (S52). The mean and the variance are calculated as illustrated in FIG. 10. In this case, when all of the output data of the convolution operation have positive values, the mean and the variance can be determined from the positive value statistical information. Conversely, when all of the output data of the convolution operation have negative values, the mean and the variance can be determined from the negative -value statistical information.

Next, the DL execution processor calculates normalized output data by subtracting the mean from each output data sample of the convolution operation and dividing the result by the square root of the variance +ε (S53). This normalization operation is likewise performed as illustrated in FIG. 10.

Further, the DL execution processor multiplies a learned parameter γ by each of the normalized output data samples determined in S53, adds a learned parameter β thereto, and then returns the distribution to the original scale (S54).

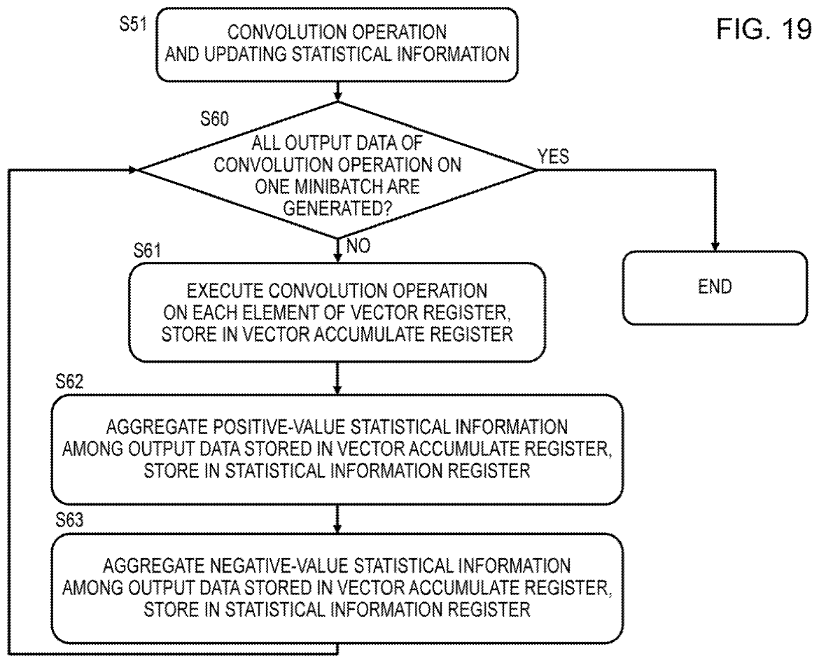

FIG. 19 is a flowchart illustrating in detail the processing of S51 for performing the convolution operation and updating the statistical information in FIG. 18. The example illustrated in FIG. 19 is an example of a vector operation performed by the vector arithmetic unit of the DL execution processor depicted in FIG. 11.

The DL execution processor repeats the processing of S61, S62, and S63 until all of the output data of the convolution operation in one minibatch are generated (S60). In the DL execution processor, the integer arithmetic units INT of the eight elements EL0-EL7 in the vector arithmetic unit execute convolution operations respectively in the eight elements of the vector register and store eight sets of operation output data in the eight elements of the vector accumulate register VC_ACC (S61).

Next, the eight statistical information acquisition devices ST_AC of the eight elements EL0-EL7 in the vector arithmetic unit and the statistical information aggregators ST_AGR_1, ST_AGR_2 aggregate the statistical information relating to the positive output data, among the eight sets of output data stored in the accumulate register, add the result to a value in one statistical information register in the statistical information register file ST_REG_FL, and store the result (S62).

Similarly, the eight statistical information acquisition devices ST_AC of the eight elements EL0-EL7 in the vector arithmetic unit and the statistical information aggregators ST_AGR, ST_AGR_2 aggregate the statistical information relating to the negative output data, among the eight output data stored in the accumulate register, add the result to a value in one statistical information register in the statistical information register file ST_REG_FL, and store the result (S63).

By repeating the processing of S61, S62, and S63, described above, until all of the output data of the convolution operation in one minibatch have been generated, the DL execution processor tallies the number of leftmost set bit for positive number or the leftmost zero bit for negative number of the output data for each bit with respect to all of the output data. As a result, as illustrated in FIG. 25, one statistical information register of the statistical information register file ST_REG_FL includes 40 registers storing numbers corresponding respectively to the 40 bits of the accumulated data in the accumulate register.

Acquisition, Aggregation, and Storage of Statistical Information Next, acquisition, aggregation, and storage of the statistical information relating to the operation output data by the DL execution processor will be described. The statistical information is acquired, aggregated, and stored using an instruction transmitted from the host processor and executed by the DL execution processor as a trigger. Hence, the host processor transmits an instruction to acquire, aggregate, and store the statistical information to the DL execution processor in addition to the operation instructions relating to the respective layers of the DNN.

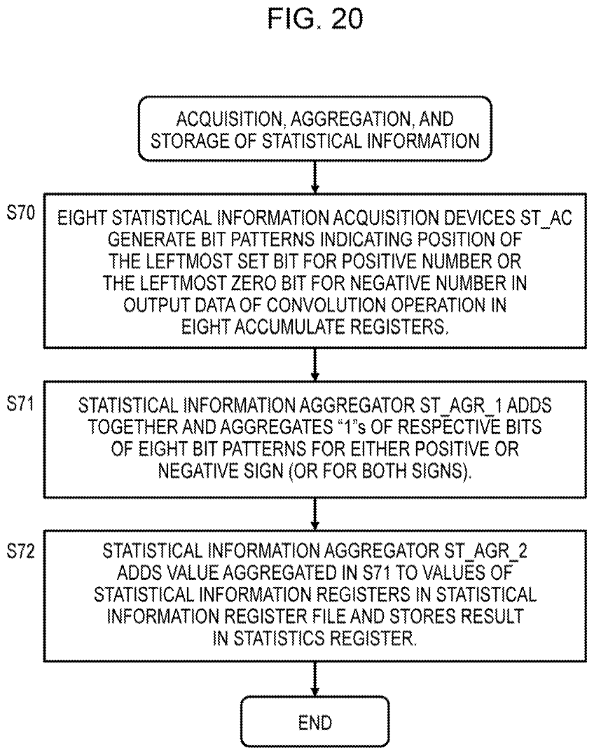

FIG. 20 is a flowchart illustrating the processing executed by the DL execution processor to acquire, aggregate, and store the statistical information. First, the eight statistical information acquisition devices ST_AC of the vector arithmetic unit respectively output bit patterns indicating the positions of the leftmost set bit for positive number or the leftmost zero bit for negative number of the operation output data of the convolution operation, output by the integer arithmetic units INT (S70).

Next, a statistical information aggregator ST_AGR_1 adds together, and thereby aggregates, the “1”s of the respective bits of the eight bit patterns for either the positive sign or the negative sign. Alternatively, the statistical information aggregator ST_AGR_1 adds together, and thereby aggregates, the “1”s of the respective bits of the eight bit patterns for both the positive sign and the negative sign (S71).

Further, a statistical information aggregator ST_AGR_2 adds the value added and aggregated in S71 to the value in a statistical information register of the statistical information register file ST_REG_FL and stores the result in the statistical information register (S72).

The processing of S70, S71, and S72, described above, is repeated every time operation output data are generated as the result of the convolution operations performed by the eight elements EL0-EL7 in the vector arithmetic unit. Once all of the operation output data in one batch have been generated and the processing described above for acquiring, aggregating, and storing the statistical information is complete, statistical information constituted by numbers of bins on histograms of the leftmost set bit for positive number or the leftmost zero bit for negative numbers of all of the operation output data in one minibatch is generated in the statistical information registers. As a result, the sum of the positions of the leftmost set bit for positive number or the leftmost zero bit for negative number of the operation output data in one minibatch is tallied for each bit

Acquisition of Statistical Information

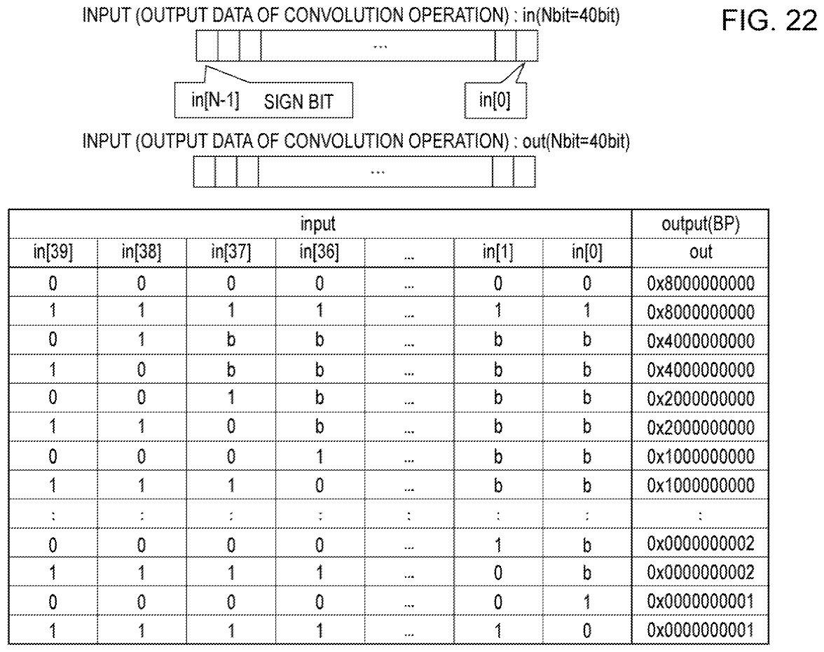

FIG. 21 is a view illustrating an example of a logic circuit of the statistical information acquisition device ST_AC. Further, FIG. 22 is a view illustrating the bit pattern of the operation output data, acquired by the statistical information acquisition device. The statistical information acquisition device ST_AC inputs N bits (N=40) of operation output data in[39:0] of the convolution operation, for example, output by the integer arithmetic unit INT, and outputs a bit pattern output out[39:0] on which the positions of the leftmost set bit for positive number or the leftmost zero bit for negative number are indicated by “1” and everything else is indicated by “0”.

As illustrated in FIG. 22, the statistical information acquisition device ST_AC outputs, with respect to the input in[39:0] that is the operation output data, the output out[39:0] in the form of a bit pattern on which the positions of the leftmost set bit for positive number or the leftmost zero bit for negative number (1 or 0 different from the sign-bit) are indicated by “1” and the remaining positions are indicated by “0”. Note, however, that when all of the bits of the input in[39:0] are identical to the sign bit, the most significant bit out[39] is set exceptionally at “1”. FIG. 22 illustrates a truth table of the statistical information acquisition device ST_AC.

On this truth table, the first two rows depict an example in which all of the bits of the input in[39:0] match the sign bit “1”, “0”, and therefore the most significant bit out[39] of the output out[39:0] takes “1” (0x8000000000). The next two rows depict an example in which bit 38 in[38] of the input in[39:0] is different to the sign bit “1”, “0”, and therefore bit 38 out[38] of the output out[39:0] takes “1” and all the other bits take “C”. The bottom two rows depict an example in which bit 0 in[0] of the input in[39:0] is different to the sign bit “1”, “0”, and therefore bit 0 out[0] of the output out[39:0] takes “1” and all the other bits take “0”.

The logic circuit illustrated in FIG. 21 detects the position of the leftmost set bit for positive number or the leftmost zero bit for negative number as follows. First, when the sign bit in[39] and in[38] do not match, the output of EOR38 takes “1”, whereby the output out[38] takes “1”. When the output of EOR38 is “1”, the other outputs out[39] and out[37:0] take “0” through logical sums OR37-OR0, logical products AND37-AND0, and an invert gate INV.

Further, when the sign bit in[39] matches in[38] but does not match in[37], the output of EOR38 takes “0” and the output of EOR37 takes “1”, whereby the output out[37] takes “1”. When the output of EOR37 is “1”, the other outputs out[39:38] and out[36:0] take “0” through the logical sums OR36-OR0, the logical products AND36-AND0, and the invert gate INV. This pattern applies likewise thereafter.

As is evident from FIGS. 21 and 22, the statistical information acquisition device ST_AC outputs distribution information including the positions of the most significant bits of the operation output data that take either “1” or “0” in contrast to the sign bit in the form of a bit pattern.

Aggregation of Statistical Information

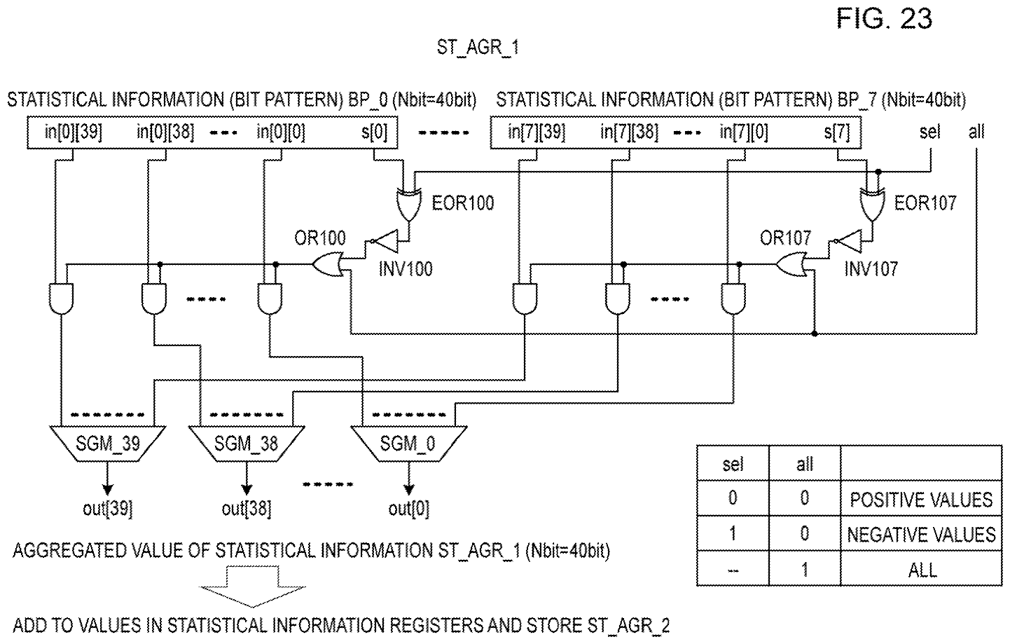

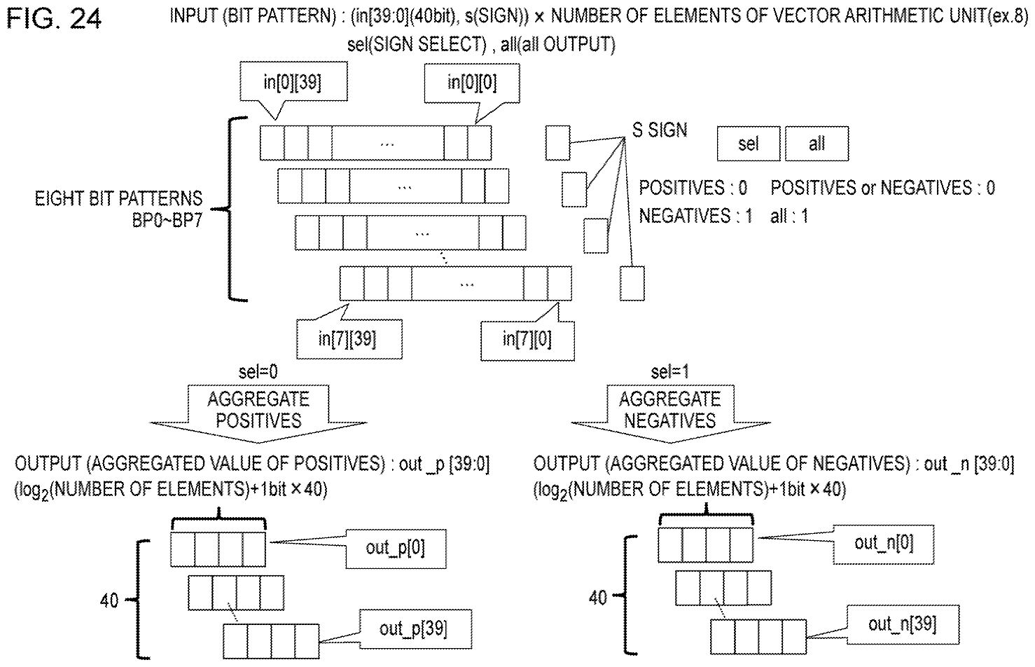

FIG. 23 is a view illustrating an example of a logic circuit of the statistical information aggregator ST_AGR_1. Further, FIG. 24 is a view illustrating an operation of the statistical information aggregator The statistical information aggregator ST_AGR_1 selects bit patterns BP_0 to BP_7 constituting eight sets of statistical information on the basis of a first selection flag sel (sel=0 when the sign bit is “0” and sel=1 when the sign bit is “1”) and a second selection flag all (all=0 when either positive or negative is selected and all=1 when both positive and negative are selected), the first and second selection flags being control values specified by an instruction, and outputs output out[39:0] obtained by adding together the “1”s of the bits on the selected bit patterns. The bit patterns BP_0 to BP_7 input into the statistical information aggregator ST_AGR_1 each have 40 bits so as to be configured thus: BP_0 to BP_7=in[0] [39:0] to in[7] [39:0].

A sign bit s[0] is added to each bit pattern BP. In FIG. 17, the sign bits is denoted as SGN output by the integer arithmetic unit INT.

As shown in FIG. 24, therefore, the input of the statistical information aggregator ST_AGR _1 is constituted by the bit patterns in[39:0], the signs s, the sign select control value sel specifying positive or negative, and the all select control value all indicating whether or not both positive and negative are selected. FIG. 23 depicts a logical value table of the sign select control value sel and the all select control value all.

On this logical value table, when the sign select control value sel=0, the all select control value all=0, and therefore the statistical information aggregator STAGR_1 cumulatively adds the number of 1s of the bits in the positive-value bit patterns BP having a sign s=0 that matches the control value sel=0 and outputs an aggregate value of the statistical information as the output [39:0]. When, on the other hand, the sign select control value sel=1, the all select control value all=0, and therefore the statistical information aggregatorST_AGR_1 cumulatively adds the number of 1s of the bits in the negative-value bit patterns BP having a sign s=1 that matches the control value sel=1 and outputs an aggregate value of the statistical information as the output [39:0]. Furthermore, when the all select control value all=1, the statistical information aggregator cumulatively adds the number of is of the bits in all of the bit patterns BP and outputs an aggregate value of the statistical information as the output [39:0].

As illustrated on the logical circuit in FIG. 23, the bit patterns BP_0 to BP_7 corresponding to the eight elements are respectively provided with EOR100-EOR107 and inverters INV100-INV107 for detecting whether or not the sign select control value sel matches the sign s, and logical sums OR100-OR107 for outputting “1” when the sign select control value sel matches the sign s or when the all select control value all=1. The statistical information aggregator ST_AGR_1 adds together the “1”s of the bits in the bit patterns BP in relation to which the output of the logical sums OR100-OR107 is “1” using addition circuits SGM_0-SGM_39, and generates the addition results as the output out[39:0].

As indicated by the output in FIG. 24, the output is based on the sign select control value sel and is therefore a positive aggregate value out_p[39:0] when sel=0 or a negative aggregate value out_n[39:0]' when sel=1. The bits of the output out_p[0]-out_p[39] and out_n[0]-out_n[39] are constituted by log₂ (number of elements=8)+1 bits so that a maximum value of 8 can be counted, and when the number of elements is 8, the number of bits is log₂2³=4.

FIG. 25 is a view depicting an example of the second statistical information aggregator ST_AGR_2 and the statistical information register file ST_REG_FL. The second statistical information aggregator ST_AGR_2 adds the values of the bits of the output out[39:0] aggregated by the first statistical information aggregator ST_AGR_1 to the values in one register set STRn_0-STRn_39 of the statistical information register file and stores the result in the one register set.

The statistical information register file. ST_REG_FL includes n sets (n=0 to 7) of 40 32-bit registers STRn_39 to STRn_0, for example, and is therefore capable of storing the numbers of data (or samples) in 40 bins of each of n histograms. It is assumed here that the aggregation subject statistical information is stored in the 40 32-bit registers STR0_39 to STR0_0 of n=0. The second statistical information aggregator ST_AGR,_2 includes adders ADD_39 to ADD_0 for adding the values of the aggregated values in[39:0] aggregated by the first statistical information aggregator ST_AGR_1 respectively to the cumulatively added values stored in the 40 32-bit registers STR0_39 to STR0_0. The outputs of the adders ADD_39 to ADD_0 are then stored again in the 40 32-bit registers STR0_39 to STR0_0. As a result, the numbers of samples in each of the bins of the subject histograms are stored in the 40 32-bit registers STR0_39 to STR0_0.

Using the hardware circuits of the statistical information acquisition device ST_AC and the statistical information aggregators ST_AGR_1, ST_AGR_2 provided in the arithmetic units illustrated in FIGS. 17 and 21 to 25, the distribution (the number of samples in each bin of the histogram) of the bits constituting the binary number of the operation output data resulting from the convolution operation, for example, can be acquired. As a result, as illustrated in FIG. 10, the mean and the variance acquired in the batch normalization processing can be determined by simpler operations.

Examples of Calculation of Mean and Variance

Examples of calculation of the mean and the variance of the operation output data by the vector arithmetic unit will be described below. As an example, the vector arithmetic unit includes eight elements of arithmetic units and therefore calculates eight elements of data in parallel. Further, in this embodiment, the mean and the variance are calculated using the approximate values +2^{e+i}, −2^{e+i} corresponding to the bit position “i” of the leftmost set bit for positive number or the leftmost zero bit for negative number as the values of the operation output data. The arithmetic expressions for calculating the mean and the variance are as described in S21 and S22 of FIG. 10. Here, 2^{e} is a scale of the operation output,

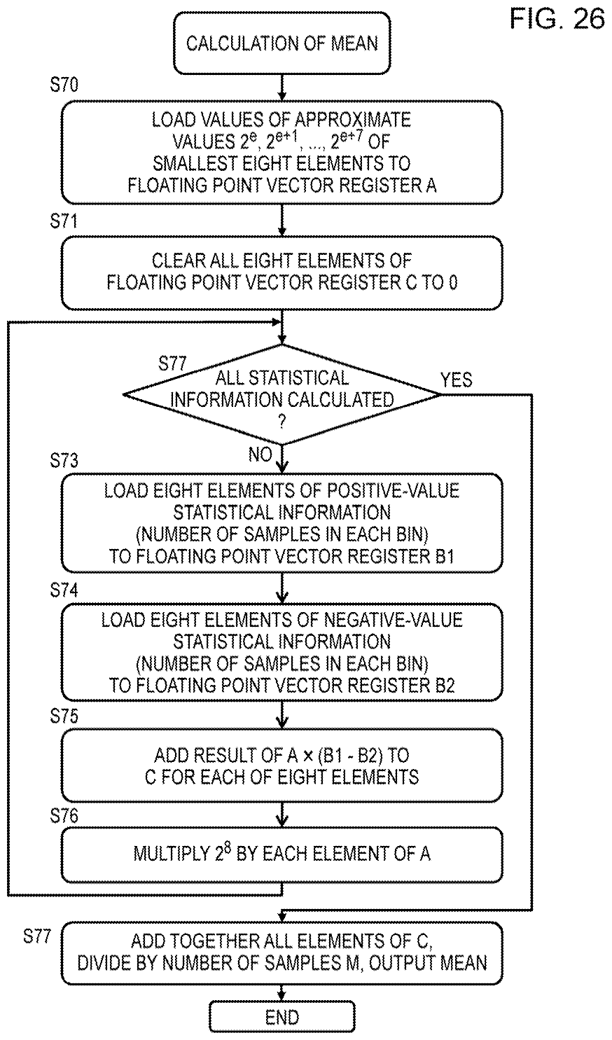

FIG. 26 is a flowchart illustrating an example of the processing executed by the DL execution processor to calculate the mean. The DL execution processor loads the approximate values 2^{e}, 2^{e+i}, . . . , 2^{e+7} of the smallest eight bins of a histogram of the leftmost set bit for positive number or the leftmost zero bit for negative number that is the statistical information to a floating point vector register A (S70). Further, the DL execution processor clears all eight elements of a floating point vector register C to 0 (S71).

Next, the DL execution processor executes the following processing until calculation has been completed with respect to all of the statistical information (NO in S72). First, the DL execution processor loads the eight elements on the smallest bit side of the positive-value statistical information to a floating point vector register B1 (S73) and loads the eight elements on the smallest bit side of the negative-value statistical information to a floating point vector register B2 (S74).

The histogram (statistical information) depicted in FIG. 9 includes 20 bins corresponding to 20 bits, namely −8 to +11, on the horizontal axis, and in this case, the eight elements on the smallest bit side denotes the number of samples in each of the eight bins −8 to −1. In accordance with the eight elements of vector arithmetic unit, the eight elements on the smallest bit side are loaded respectively to the floating point vector registers B1, B2.

The floating point arithmetic units FP of the eight elements of the vector arithmetic unit VC_AR_UNIT then calculate A×(B1−B2) in relation to the data in the eight elements of the registers A, B1, B2 and add the calculation results of the eight elements to the values in the respective elements of the floating point vector register C (S75). At that point, calculation with respect to the eight bins on the smallest bit side of the histogram is complete.

Hence, in order to perform calculation with respect to the next eight bins (the eight bins 0 to +7) of the histogram, the DL execution processor multiplies 2⁸ by the values in the respective elements of the floating point vector register A using the floating point arithmetic units of the eight elements of the vector arithmetic unit (S76) and stores the result in the respective elements of the floating point vector register A. The DL execution processor then executes the processing of S72 to S76. In the processing of S73 and S74, the next eight elements (the numbers of samples in the next eight bins) of the positive-value statistical information and the next eight elements (the numbers of samples in the next eight bins) of the negative-value statistical information are loaded respectively to the registers B1, B2.

In the example of FIG. 9, once the processing of S72 to S76 has been executed in relation to the next four bins (+8 to +11) of the histogram, calculation of all of the statistical information is complete (YES in S72), and therefore the DL execution processor adds together all of the eight elements in the floating point vector register C, divides the added value by the number of samples M, and outputs the mean.

The operations described above are performed using the eight elements of floating point arithmetic units FP in the vector arithmetic unit, but when a sufficient number of bits can be processed using the eight elements of integer arithmetic units INT in the vector arithmetic unit, the operations may be performed using the integer arithmetic units.

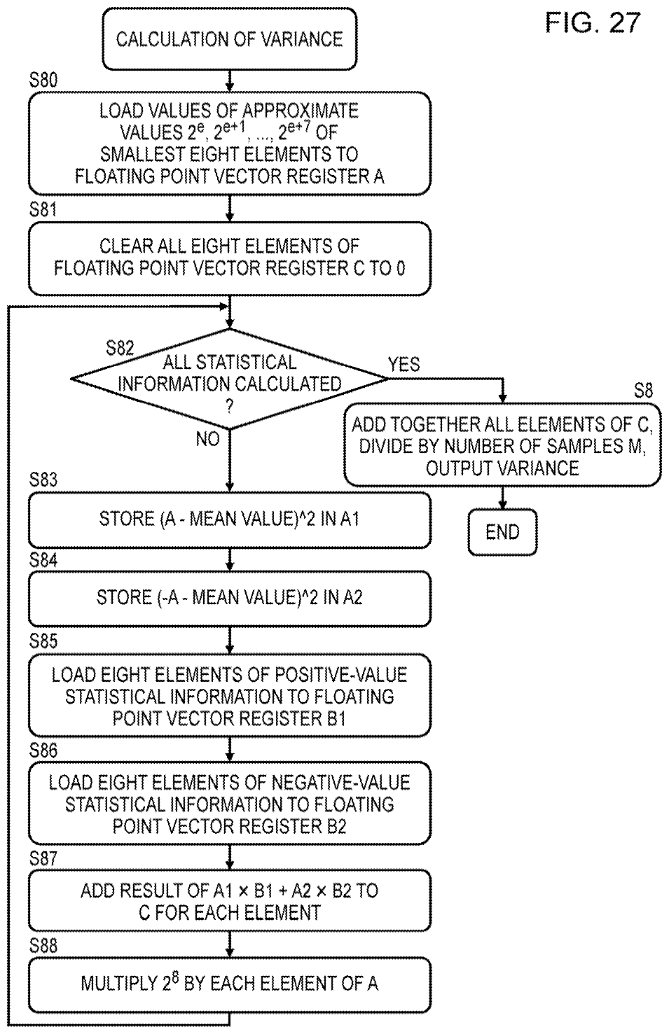

FIG. 27 is a flowchart illustrating an example of the processing to calculate the variance executed by the DL execution processor. The DL execution processor loads the approximate values 2^{e}, 2^{e+1}, . . . , 2^{e+7} of the smallest eight bins of the histogram of the leftmost set bit for positive number or the leftmost zero bit for negative number that is the statistical information to the floating point vector register A (S80). Further, the DL execution processor clears all eight elements of the floating point vector register C to 0 (S81).

Next, the DL execution processor executes the following processing until calculation has been completed with respect to all of the statistical information (NO in S82). First, the DL execution processor squares the respective differences between the eight approximate values A in the register A and the mean value, and stores the calculation results in the eight elements of a floating point vector register A1 (S83). Further, the DL execution processor squares the respective differences between negatives −A of the eight approximate values A in the register A and the mean value, and stores the calculation results in the eight elements of a floating point vector register A2 (S84).

The DL execution processor then loads the eight elements on the smallest bit side of the positive-value statistical information to the floating point vector register B1 (S85) and loads the eight elements on the smallest bit side of the negative-value statistical information to the floating point vector register B2 (S86).

Further, in the DL execution processor, the eight elements of floating point arithmetic units in the vector arithmetic unit multiply the data in the eight elements of the registers A1 and B1, multiply the data in the eight elements of the registers A2 and B2, add together the respective multiplication values, add the addition results of the eight elements respectively to the data in the eight elements of the register C, and store the results respectively in the eight elements of the register C (S87). At that point, calculation with respect to the eight bins on the smallest bit side of the histogram is complete.

Hence, in order to perform calculation with respect to the next eight bins (the eight bins 0 to +7) of the histogram, the DL execution processor multiplies 2⁸ by the respective values in the elements of the floating point vector register A using the eight elements of floating point arithmetic units in the vector arithmetic unit (S88). The DL execution processor then executes the processing of S82 to S88. In the processing of S83 and S84, calculations are performed with respect to new approximate values 2^{e+8}, 2^{e+9}, . . . , 2^{e+15} in the register A. Further, in the processing of S85 and S86, the next eight elements (the numbers of samples in the next eight bins) of the positive-value statistical information and the next eight elements (the numbers of samples in the next eight bins) of the negative-value statistical information are loaded respectively to the registers B1, B2.

In the example of FIG. 9, once the processing of S82 to S88 has been executed in relation to the next four bins (+8 to +11) of the histogram, calculation of all of the statistical information is complete (YES in S82), and therefore the DL execution processor adds together all of the eight elements in the floating point vector register C, divides the added value by the number of samples M, and outputs the variance.

The operations described above are also performed using the eight elements of floating point arithmetic units FP in the vector arithmetic unit, but when a sufficient number of bits can be processed using the eight elements of integer arithmetic units INT in the vector arithmetic unit, the operations may be performed using the integer arithmetic units.

Finally, the eight elements of floating point arithmetic units FP in the vector arithmetic unit execute the normalization operation illustrated in the processing of S13 in FIG. 7 on all of the operation output data, eight samples at a time, and write the normalized operation output data to a vector register or the memory.

Modified Example of Normalization Operation

In the above embodiment, divisive normalization, in which the mean and variance of the operation output data x are determined, the mean is subtracted from the operation output data x, and the result is divided by the square root (the standard deviation) of the variance was described as an example of the normalization operation. As another example of the normalization operation, however, this embodiment may also be applied to subtractive normalization, in which the mean of the operation output data is determined and the mean is subtracted from the operation output data.

Example of Data subject to Normalization Operation

In the above embodiment, an example of normalization of the operation output data x of an arithmetic unit was described. However, this embodiment may also be applied to normalization of a plurality of input data of a minibatch.

In this case, calculation of the mean value can be simplified using the numbers of samples and the approximate values of the bins of a histogram obtained by acquiring and aggregating the statistical information of a plurality of input data.

In this specification, the normalization subject data (the normalization subject data or the subject data) include operation output data, input data, and so on.

Example of Bins of Histogram

In the above embodiment, a logarithm (log₂X) of the operation output data X to base 2 was set as the unit of the bins. However, a multiple of two of the above logarithm (2×log₂X) may be set as the unit of the bins. In this case, a distribution (a histogram) of the leftmost even number set bits for positive number or the leftmost even number zero bits for negative number of the operation output data X is acquired as the statistical information such that the range of the bins is 2^{e+2i} to 2^{e+2(i+1)} (where i is an integer of 0 or more) and the approximate value is 2^{e+2i}.

Example of Approximate Value

In the above embodiment, the approximate value of each bin is set at the value 2^{e+i} of the leftmost set bit for positive number or the leftmost zero bit for negative number. However, when the range of the bins is 2^{e+i} to 2^{e+i+1} (where i is an integer of 0 or more), the approximate value may be set at (2^{e+i}+2^{e+i+1})/2.

According to this embodiment, as described above, a distribution (a histogram) of the leftmost set bit for positive number or the leftmost zero bit for negative number of input data or intermediate data (operation output data) in a DNN can be acquired as statistical information, and the mean and variance determined in a normalization operation can be calculated easily using approximate values +2^{e+i}, −2^{e+i} of the respective bins of the histogram and the numbers of data samples in the respective bins. As a result, reductions can be achieved in the amount of power consumed by a processor during the normalization operation and the amount of time used for learning.

According to the present embodiment, a normalization operation can be accelerated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is;

1. An arithmetic processing device comprising:
an arithmetic circuit;
a register which stores operation output data that is output by the arithmetic circuit;
a statistics acquisition circuit which generates, from subject data that is either the operation output data or normalization subject data, a bit pattern indicating a position of a leftmost set bit for positive number or a position of a leftmost zero bit for negative number of the subject data; and
a statistics aggregation circuit which generates either positive statistical information or negative statistical information, or both positive and negative statistical information, by separately adding up a first number at respective bit positions of the leftmost set bit indicated by the bit pattern of each of a plurality of subject data having a positive sign bit and a second number of at respective bit positions of leftmost zero bit indicated by the bit pattern of each of a plurality of subject data having a negative sign bit.

2. The arithmetic processing device according to claim 1, wherein the statistics aggregation circuit generates positive and negative total statistical information by adding up a third number at respective bit positions of the leftmost set bit for positive number or a position of a leftmost zero bit for negative number indicated by the bit pattern of each of a plurality of subject data having a positive sign bit and a plurality of subject data having a negative sign bit.

3. The arithmetic processing device according to claim 1, wherein the statistics aggregation circuit generates the positive statistical information or the negative statistical information by adding up the first number or the second number on the basis of a control bit indicating either a positive sign bit or a negative sign bit.

4. The arithmetic processing device according to claim 1, wherein the arithmetic circuit determines multiplication values by multiplying input data that is input respectively into a plurality of nodes in an input layer of a deep neural network by weights of edges corresponding to the nodes between the input layer and an output layer, and calculates the operation output data for each of a plurality of nodes in the output layer by cumulatively adding the multiplication values,
the statistics aggregation circuit generates the bit pattern of the operation output data calculated by the arithmetic circuit, and
the arithmetic circuit stores the operation output data in the register.

5. The arithmetic processing device according to claim 1, wherein the arithmetic circuit calculates a mean value of the operation output data on the basis of the first number, the second number, and approximate values corresponding to the position of the leftmost set bit for positive number or a position of a leftmost zero bit for negative number of the operation output data.

6. The arithmetic processing device according to claim 5, wherein the arithmetic circuit calculates a variance value of the operation output data on the basis of the approximate values of the operation output data and the mean value.

7. The arithmetic processing device according to claim 6, wherein the arithmetic circuit performs a normalization operation on the operation output data by subtracting the mean value from the operation output data and dividing the subtracted value by a square root of the variance value.

8. The arithmetic processing device according to claim 1, wherein the arithmetic circuit calculates a mean value of the normalization subject data on the basis of the first number, the second number, and approximate values corresponding to the position of the leftmost set bit for positive number or a position of a leftmost zero bit for negative number of the normalization subject data.

9. The arithmetic processing device according to claim 8, wherein the arithmetic circuit calculates a variance value of the normalization subject data on the basis of the approximate values of the normalization subject data and the mean value.

10. The arithmetic processing device according to claim 9, wherein the arithmetic circuit performs a normalization operation on the normalization subject data by subtracting the mean value from the normalization subject data and dividing the subtracted value by a square root of the variance value.

11. A non-transitory computer-readable storage medium storing therein a learning program for causing a computer to execute a learning process in a deep neural network, the learning process comprising:
reading, from a memory, statistical data of a histogram having, as a number of respective bins, a number at respective bit positions of a leftmost set bit for positive number or a position of a leftmost zero bit for negative number within subject data that is either a plurality of operation output data output by an arithmetic circuit or a plurality of normalization subject data,
calculating a mean value and a variance value of the subject data on the basis of the number of the respective bins, and approximate values each corresponding to the position of the leftmost set bit for positive number or a position of a leftmost zero bit for negative number of the subject data, and
performing a normalization operation on the subject data on the basis of the mean value and the variance value.

12. A learning method for causing a processor to execute a learning process in a deep neural network, the learning process comprising:
reading, from a memory, statistical data of a histogram having, as a number of respective bins, a number at respective bit positions of a leftmost set bit for positive number or a position of a leftmost zero bit for negative number within subject data that is either a plurality of operation output data output by an arithmetic circuit or normalization subject data,
calculating a mean value and a variance value of the subject data on the basis of the number of the respective bins and approximate values each corresponding to the position of the leftmost set bit for positive number or a position of a leftmost zero bit for negative number of the subject data, and
performing a normalization operation on the subject data on the basis of the mean value and the variance value.
